(19) United States
(12) Patent Application Publication
(10) Pub. No.: US 2013/0097777 A1
(43) Pub. Date: Apr. 25, 2013

(54) FLUID DELIVERY SYSTEMS FOR CLIMATE CONTROLLED SEATS

(71) Applicant: GENTHERM INCORPORATED, Northville, MI (US)

(72) Inventors: David Marquette, Farmington Hills, MI (US); John Terech, Milan, MI (US)

(73) Assignee: GENTHERM INCORPORATED, Northville, MI (US)

(21) Appl. No.: 13/652,189

(22) Filed: Oct. 15, 2012

Related U.S. Application Data
(63) Continuation of application No. 12/167,190, filed on Jul. 2, 2008.
(60) Provisional application No. 60/947,605, filed on Jul. 2, 2007.

(51) Int. Cl. A47C 7/74; A47C 21/04; B60N 2/56

(52) U.S. Cl. CPC A47C 7/748; B60N 2/5685; B60N 2/5657; A47C 21/048
USPC 5/423; 297/180.12; 297/180.13

(57) ABSTRACT

A seat portion or a backrest portion of seating assembly comprises a recessed area or wide groove along its exterior surface. The recessed area can be configured to receive a spacer (e.g., spacer fabric, member, module, etc.) that helps maintains the spatial and structural integrity of the recessed area. In addition, a scrim layer can be positioned over the spacer fabric to help direct and/or distribute air or other fluid to an exterior surface of the seating assembly. The recessed area can also be configured to receive one or more films, occupant sensory devices, comfort layers, scrims, temperature sensors, heating devices and/or the like.

### CROSS-REFERENCE TO RELATED APPLICATIONS

This application is a continuation application of U.S. patent application No. 12/167,190, filed Jul. 2, 2008, which claims the priority benefit under 35 U.S.C. §119(e) of U.S. Provisional Application No. 60/947,605, filed Jul. 2, 2007, the entireties of both of which are hereby incorporated by reference herein.

### BACKGROUND

1. Field

This application relates generally to climate control, and more specifically, to climate control of a seat assembly.

2. Description of the Related Art

Temperature modified air for environmental control of living or working space is typically provided to relatively extensive areas, such as entire buildings, selected offices, suites of offices or other rooms and/or the like. In the case of vehicles, such as automobiles, the entire vehicle is typically cooled or heated as a unit. There are many situations, however, in which more selective or restrictive air temperature modification is desirable. For example, it is often desirable to provide an individualized climate control for a seat so that substantially instantaneous heating or cooling can be achieved. For example, a vehicle exposed to the summer weather (e.g., where the vehicle has been parked in an unshaded area for a long period of time) can cause one or more of the vehicle seats to become hot and generally uncomfortable for the occupant for some time after first entering and beginning to use the vehicle. This may be the case even if the vehicle's air conditioning system (e.g., automotive HVAC) is being operated. Furthermore, even with normal air-conditioning, the seat occupant's back and other pressure points may remain uncomfortably hot and/or sweaty. Under cold conditions, it may be desirable to relatively quickly warm a seat portion, especially where the vehicle's heating system is unlikely to warm the vehicle's interior as quickly.

For such reasons, there have been provided various types of individualized climate control systems for vehicle seats (see e.g., U.S. Pat. Nos. 7,114,771 and 6,869,139). Such climate control systems typically include a distribution system comprising a combination of channels and passages formed in the cushion of the seat. Climate conditioned air is supplied to these channels and passages by a climate control device. The climate conditioned air flows through the channels and passages to cool or heat the space adjacent the surface of the vehicle seat.

There are, however, problems that have been experienced with existing climate control systems for seat assemblies. For example, the distribution system can be difficult to install and/or require a large number of components that results in increased steps during assembly. In addition, many of the existing control systems for seat assemblies include relatively thick profiles that tend to interfere with the manufacture of the assembly and/or decrease an occupant's comfort level. With the increased popularity of climate controlled vehicle seats, car manufacturers are increasingly looking for climate control systems that can be installed more easily and for systems that can provide the comparable performance at a lower cost.

### SUMMARY

According to some embodiments of the present application, a climate control assembly for a seat includes a cushion having an outer surface comprising a first side for supporting an occupant and a second side, the first side and the second side facing generally in opposite directions. In addition, the climate control system includes one or more fluid passages extending from the first side to the second side of the cushion and a recessed area along the first side of the cushion. In one embodiment, the recessed area is in fluid communication with the fluid passage. The assembly further comprises a spacer positioned within the recessed area. The spacer can be at least partially fluid permeable and configured to substantially retain the spatial integrity of the recessed area. In some arrangements, the recessed area occupies at least about half of a surface area of the first side of the cushion.

In some embodiments, the recessed area is configured to further receive a scrim which includes at least one opening through which fluids may pass. In one arrangement, the scrim comprises a plurality of openings. In other embodiments, the scrim comprises a single opening having an area generally greater than one-half of the total area of the scrim. In one embodiment, the scrim comprises one or more padding layers configured to generally enhance the comfort to a seated occupant. In yet other arrangements, the recessed area includes a bottom surface and at least one side surface. In one embodiment, the recessed area includes at least one film layer to cover at least of the bottom surface and the side surfaces. In another embodiment, the film layer comprises an air permeability that is lower than an air permeability of the spacer.

In some arrangements, the film layer is attached to the spacer. In yet other embodiments, the recessed area comprises a generally rectangular shape, another polygonal shape, a circular or other curved shape, an irregular shape and/or the like. In one embodiment, the fluid passage is configured to be in fluid communication with a fluid module. In some configurations, the fluid module comprises a fluid transfer device. In other arrangements, the fluid module further comprises a thermoelectric device configured to selectively heat or cool a fluid. In some arrangements, the climate control assembly additionally comprises an occupant sensing device configured to detect when an occupant is seated within the seat.

In one embodiment, the assembly further comprises a resistive heater (e.g., a heating mat) and/or another type of heating element of device. In some arrangements, the heating element is generally positioned between the bottom surface of the recessed area and an exterior surface of the seat. In other embodiments, the heating element is generally integrated with the spacer or is permanently or removably attached to it. In some embodiments, the heating element comprises a plurality of slots or other openings, which are configured to permit a fluid to pass therethrough.

In some arrangements, the climate control assembly is configured to be positioned within an automobile seat, another type of vehicle seat, a bed, a sofa, a chair and/or the like. In one embodiment, the first side of the cushion comprises at least one pocket which is in fluid communication with the recessed area. The pocket is configured to deliver a volume of fluid to a targeted region of the cushion (e.g., legs, thighs, lower back, neck, shoulders, etc.). In some arrangements, the pockets are coextensive with the recessed area. In another embodiment, the spacer comprises a unitary member that is shaped and sized to fit within both the recessed area and the pocket. In other arrangements, the pocket is separate from the recessed area. In yet other embodiments, the pocket and the recessed area are in fluid communication using a channel formed on the first side of the cushion. In still another configuration, the pocket and the recessed area are in fluid communication using a channel formed on the second side of the cushion. In one embodiment, the pocket and the recessed area are in fluid communication using a conduit positioned within the cushion, generally between the first and second sides of the cushion.

In some arrangements, the fluid module is configured to deliver fluid through the fluid passage in a direction generally from the first side to the second side of the cushion. However, in other embodiments, the fluid module is configured to deliver fluid through the fluid passage in a direction generally from the second side to the first side of the cushion. In still other embodiments, the climate control assembly additionally comprises a second fluid module and a second fluid passage, such that the second fluid module is further configured to deliver fluid through the second fluid passage in a direction generally from the second side to the first side of the cushion. In some arrangements, the spacer comprises a spacer fabric, member or the like. In other embodiments, the fluid passage is configured to be selectively placed in fluid communication with a vehicle's or a building's air conditioning system (e.g., HVAC system).

According to some embodiments, a climate controlled seat assembly includes a cushion having an outer surface comprising a first side for supporting an occupant and a second side, the first side and the second side facing generally in opposite directions. The seat assembly further comprises one or more fluid passages extending from the first side to the second side of the cushion and a recessed area along the first side of the cushion, the recessed area being in fluid communication with the fluid passage. In addition, the seat assembly includes a spacer positioned within the recessed area, the spacer being at least partially fluid permeable and being configured to substantially retain the spatial integrity of the recessed area. In some embodiments, the recessed area comprises a depth between 5 and 15 mm. In other arrangements, the depth of the recessed area can be greater than 15 mm or smaller than 5 mm.

According to some arrangements, a climate controlled seat comprises a cushion having an outer surface comprising a first side for supporting an occupant and a second side, the first side and the second side facing generally in opposite directions. The seat further includes one or more fluid passages generally extending from the first side to the second side of the cushion, a recessed area along the first side of the cushion and a spacer positioned within the recessed area, the spacer being at least partially fluid permeable and being configured to substantially retain the spatial integrity of the recessed area. The recessed is in fluid communication with the fluid passage. In some arrangements, the recessed area comprises a width to depth ratio between 8 and 40. However, in other arrangements, the width to depth ratio is greater than 40 or less than 8.

Accordingly, one aspect of the present inventions comprises a seat portion and/or a backrest portion of seating assembly comprising a recessed area or wide groove along its exterior surface. The recessed area can be configured to receive a spacer fabric that helps maintains the spatial and structural integrity of the recessed area. The spacer fabric can be generally air and fluid permeable. In addition, a scrim layer can be positioned over the spacer fabric to help direct and/or distribute air or other fluid to an exterior surface of the seating assembly. The recessed area can also be configured to receive one or more films, occupant sensory devices, heating devices and/or the like. Thus, air or other fluid can be delivered into the recessed area of a seat or backrest portion of a seating assembly, and subsequently delivered through the spacer fabric and scrim layer towards an occupant. In some embodiments, the air or fluid is conditioned (e.g., heated or cooled) prior to entering the recessed area.

Another aspect of the present invention comprises a climate controlled assembly having a cushion with an outer surface comprising a first side for supporting an occupant and a second side, the first side and the second side facing generally in opposite directions. The assembly further comprises one or more fluid passages extending from the first side to the second side of the cushion and a recessed area along the first side of the cushion. The recessed area being in fluid communication with the fluid passage. The assembly further includes a spacer fabric positioned within the recessed area, the spacer fabric being at least partially fluid permeable and being configured to substantially retain the spatial integrity of the recessed area. The recessed area occupies at least about half of a surface area of the first side of the cushion.

According to another embodiment, the recessed area is configured to further receive a scrim layer that comprises one or more openings. The scrim layer being configured to distribute fluid through the openings. In other embodiments, the scrim layer comprises a plurality of openings or just a single opening.

In some embodiments, the recessed area includes a bottom surface and at least one side surface, the recessed area comprising at least one substantially fluid impermeable film layer to cover at least of the bottom surface and the side surfaces. In one embodiment, the film layer is attached to the spacer fabric. In another embodiment, the recessed area comprises a generally rectangular shape.

According to some embodiments, the climate controlled assembly further comprises at least one covering layer. In other embodiments, the fluid passage is configured for attachment to a fluid module. In one embodiment, the fluid module comprises a thermoelectric device (e.g., Peltier device). In yet other embodiments, the climate controlled assembly further comprises an occupant sensing device and/or a heat mat or other heating device.

In some embodiments, the heat mat is positioned between the bottom surface of the recessed area and an exterior surface of the assembly. In other embodiments, the assembly comprises an automobile seat, a chair, a bed and/or the like.

Further features and advantages of the present invention will become apparent to those of ordinary skill in the art in view of the detailed description of preferred embodiments which follow, when considered together with the attached drawings and claims.

### BRIEF DESCRIPTION OF THE DRAWINGS

These and other features, aspects and advantages of the present devices, systems and methods are described in detail below with reference to drawings of certain preferred embodiments, which are intended to illustrate, but not to limit, the present inventions. The drawings contain thirty-one (31) figures. It is to be understood that the attached drawings are for the purpose of illustrating concepts of the present inventions and may not be to scale.

FIG. 1A is a perspective view of a seat assembly that includes a climate control system that is configured in accordance with one embodiment of the present inventions;

FIG. 1B is a detailed perspective view of the seat portion of the seat assembly of FIG. 1A, with certain climate control components shown in exploded view;

FIG. 1C is a detailed perspective view of the seat portion of a seat assembly with certain climate control components shown in exploded view according to a different embodiment;

FIG. 2 is a perspective view of a seat back portion of the a seat assembly according to one embodiment;

FIG. 3 is a schematic illustration of a climate control system positioned within a seat portion of a seating assembly according to one embodiment;

FIG. 4A is a perspective view of a seat assembly that includes a climate control system that is configured in accordance with another embodiment;

FIG. 4B is a detailed perspective view of the seat portion of the seat assembly of FIG. 4A, with certain climate control components shown in exploded view;

FIG. 5A is a perspective view of a seat assembly that includes a climate control system that is configured in accordance with another embodiment;

FIG. 5B is a detailed perspective view of the seat portion of the seat assembly of FIG. 5A, with certain climate control components shown in exploded view;

FIG. 6A is a perspective view of a seat assembly that includes a climate control system that is configured in accordance with another embodiment;

FIG. 6B is a detailed perspective view of the seat portion of the seat assembly of FIG. 6A, with certain climate control components shown in exploded view;

FIG. 7A is a perspective view of a seat assembly that includes a climate control system that is configured in accordance with another embodiment;

FIG. 7B is a detailed perspective view of the seat portion of the seat assembly of FIG. 7A, with certain climate control components shown in exploded view;

FIG. 8 is a detailed perspective view of the seat portion of a seat assembly having certain climate control components shown in exploded view according to one embodiment;

FIG. 9 is a detailed perspective view of the seat portion of a seat assembly having certain climate control components shown in exploded view according to another embodiment;

FIG. 10A is a perspective view of the seat portion of a seat assembly comprising a climate control system according to one embodiment;

FIG. 10B is a cross-sectional view of the seat portion of the seat assembly of FIG. 10A;

FIG. 11A is a perspective exploded view of one embodiment of a spacer module configured to be positioned within a recessed area of a seat back portion or a seat bottom portion of a seat assembly;

FIG. 11B is a perspective view of the spacer module of FIG. 11A;

FIG. 12 is a cross-sectional view of a spacer module and a fluid module positioned within a recessed area of a seat back portion or a seat bottom portion of a seat assembly according to one embodiment;

FIG. 13A is a perspective view of a recessed area within a seat bottom portion comprising a temperature sensor according to one embodiment;

FIG. 13B is a cross-sectional view of the seat bottom portion of FIG. 13A;

FIG. 14A is a top view of a seat bottom portion of a seat assembly having a recessed area and tie down trenches according to one embodiment;

FIG. 14B is a top view of a seat bottom portion of a seat assembly having two recessed areas and tie down trenches according to a different embodiment;

FIGS. 15A-15C are perspective view of a seating assembly comprising enclosures positioned within corresponding recessed areas of the seat bottom and seat back portions according to one embodiment;

FIG. 16A is a top view of one embodiment of a seat bottom portion comprising covering attachment members positioned within its tie down trenches and having a spacer assembly positioned within a recessed area;

FIG. 16B is a detailed top view of the seat bottom portion of FIG. 16A;

FIG. 16C is a top view of another embodiment of a seat bottom portion comprising covering attachment members positioned within its tie down trenches and having a spacer assembly positioned within a recessed area; and

FIG. 16D is a detailed top view of the seat bottom portion of FIG. 16C.

### DETAILED DESCRIPTION OF THE PREFERRED EMBODIMENTS

This application is generally directed to a climate control system for a seating assembly. The climate control system and the various systems and features associated with it are described in the context of an automotive seating assembly or other seat for a vehicle because they have particular utility in this context. However, the climate control system and the methods described herein, as well as their various systems and features, can be used in other contexts as well, such as, for example, but without limitation, trains, planes, motorcycles, buses, other vehicles, wheelchairs, sofas, task chairs, office chairs, other types of chairs, beds and/or the like. However, for convenience, the climate control system is described herein with specific reference to an automotive seat assembly.

In accordance with some embodiments, a seat portion or a backrest portion of seating assembly comprises a recessed area or wide groove region along its exterior surface. The recessed area can be configured to receive a spacer, spacer member or module (e.g., spacer fabric) that helps to maintain the spatial and structural integrity of the recessed area. The terms, “spacer,” “spacer material,” “spacer fabric” and “spacer module” are broad terms and may be used interchangeably herein. In some arrangements, the spacer is generally air permeable or substantially air permeable. In addition, a scrim, scrim member or layer can be positioned over the spacer to help direct and/or distribute air or other fluid to one or more portions (e.g., an exterior surface) of the seating assembly. In certain arrangements, the recessed area can also receive one or more films, occupant sensory devices, temperature sensors, comfort layers or members, heating devices and/or the like. Air or other fluid can be delivered into the recessed area of a seat bottom and/or seat back (or backrest) portion of a seating assembly, and subsequently delivered through the spacer and scrim towards an occupant. In some embodiments, the air or fluid is conditioned (e.g., heated or cooled) prior to entering the recessed area.

Advantageously, the systems, devices and methods disclosed herein can help simplify the design of seat assemblies that comprise climate control features. This can help reduce the cost and time associated with the manufacturing, assembly and/or other activities associated with providing and operating such assemblies. In addition, the embodiments disclosed and illustrated herein can help enhance the comfort level of the occupant.

In addition, the embodiments disclosed herein that include spacer assemblies generally positioned within corresponding recessed areas of a seat assembly can improve the packaging for thin foam or high pressure regions of the seat. In addition, such embodiments can help reduce the likelihood of collapse of recessed areas, channels or other conveyance regions formed within a climate controlled seating assembly. Further, such arrangements can help reduce manufacturing, assembly, operating and/or other costs. For example, the simplified design of such arrangements can help reduce the complexity of a system and/or reduce the number of components that are necessary. As discussed, the comfort to occupants may also be enhanced, as there is a more balanced pressure distribution of fluid exiting a surface of a seat bottom portion and/or a seat back portion. In addition, the embodiments described and illustrated herein can provide more uniform thermal conditioning and thermal distribution.

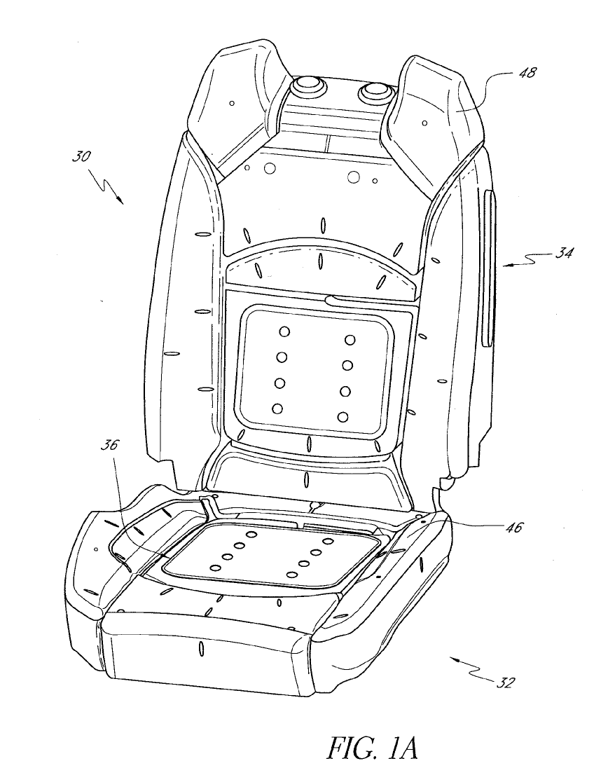

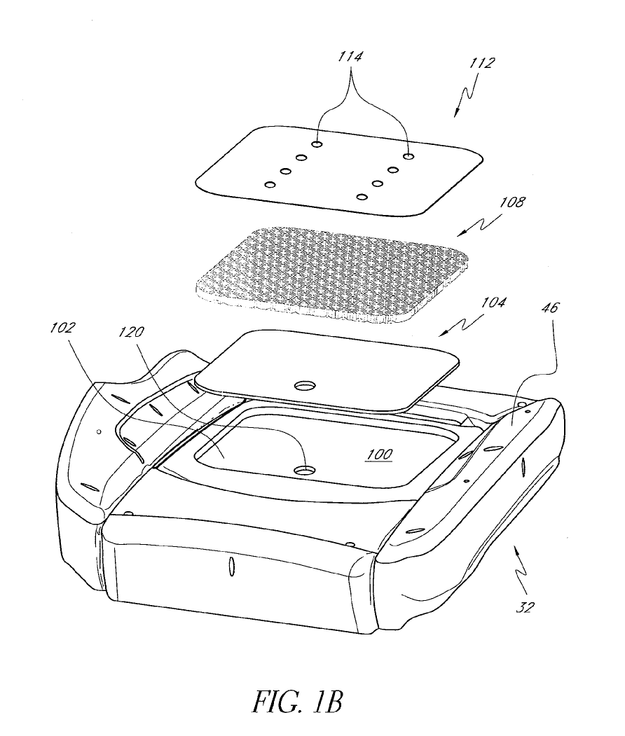

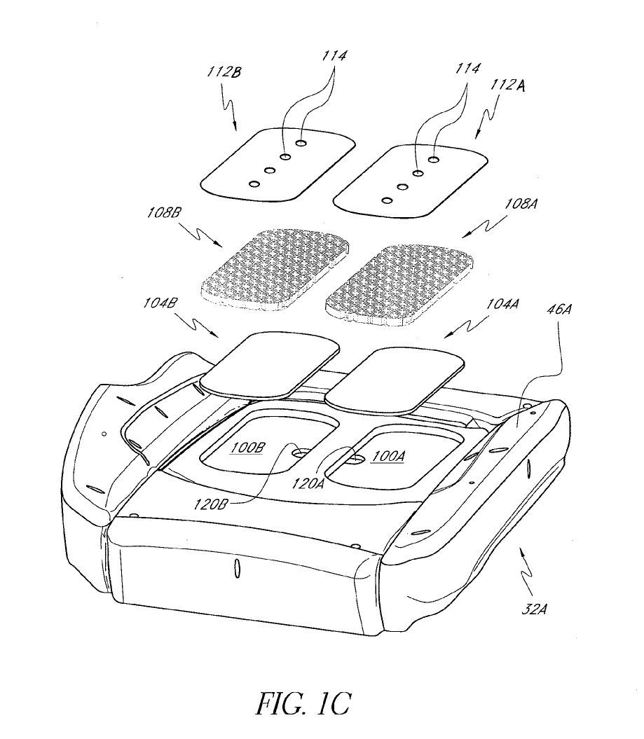

FIG. 1A is a front perspective view of an embodiment of a climate controlled seat assembly 30. As shown, the seat assembly 30 comprises a backrest 34, which can be coupled and/or used in combination with a seat bottom portion 32 to form the seat assembly 30. The seat assembly 30 preferably includes a climate control system 36, which will be described in more detail herein.

When an occupant sits in the seat assembly 30, the occupant's seat is located on a top surface 46 of the seat portion 32 and the occupant's back contacts a front surface 48 of the backrest portion 34. The backrest 34 and the seat portion cooperate to support the occupant in a sitting position. It will be appreciated that the seat assembly 30 can be configured and sized to accommodate occupants of various size and weight. In addition, while the back rest and seat portions 34, 32 are shown as separate components in other arrangements they can be integrally formed or divided into subcomponents.

In the illustrated embodiment, the seat assembly 30 is similar to a standard automotive seat. However, as discussed herein, certain features and aspects of the seat assembly 30 described herein may also be used in a variety of other applications and environments. For example, certain features and aspects of the seat assembly 30 may be adapted for use in other vehicles, such as, for example, airplanes, boats, wheelchairs and/or the like. Further, certain features and aspects of the seat assembly 30 may also be adapted for use in stationary environments, such as, for example, a chair, a sofa, a stool, a theater seat, an office seat (e.g., a chair that is used in a place of business and/or residence) and/or the like. In addition, certain features and aspects of the seat assembly 30 can be adapted for use in devices that do not support a person in a seated position, such as, for example, a bed.

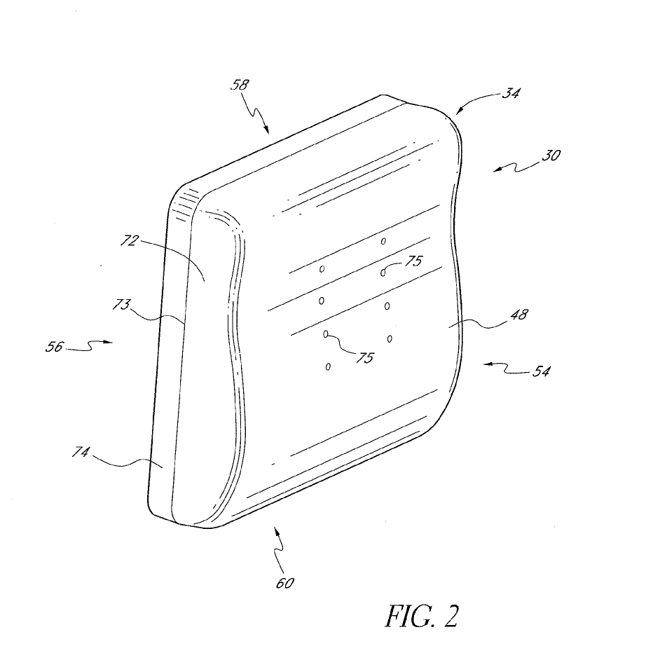

With continued reference to the embodiments illustrated in FIGS. 1A and 2, the backrest 34 has a front side 54, a rear side 56, a top side 58 and a bottom side 60. Although not illustrated, the backrest 34 can include a pair of sides that extend between the top side 58 and bottom side 60 for providing lateral support to the occupant of the seat assembly 30.

As shown, the backrest 34 is generally formed by a cushion 72, which may be covered with a covering material (not shown), such as, for example, upholstery, vinyl, leather and/or any other suitable material. Typically, the cushion 72 can be supported on a frame or support member 74. In some embodiments, springs (not shown) may be positioned between the frame 74 and the cushion 72. The frame 74 can provide the seat assembly 30 with structural support, while the cushion 72 can provide a soft seating surface. The covering material, in turn, can provide an aesthetic appearance and/or a soft feel to the surface of the seat assembly 30. In some embodiments, the cushion 72 also has a rear side 73, which is generally opposite the front side 48 of the cushion 72 and adjacent to the frame 74.

The cushion 72 can comprise an automotive seat cushion foam (e.g., closed cell foam, open cell foam, combinations thereof, etc.) or other types of materials with suitable characteristics for providing support to an occupant. Such materials include, but are not limited to, closed or open-celled foam.

FIG. 1B illustrates a detailed view of the seat bottom portion 32 of the seat assembly of FIG. 1A. For clarity, several of the climate control components of the seat portion 32 are depicted in exploded view. In the illustrated embodiment, the top surface 46 of the seat portion 32 comprises a recessed area 100 or a wide channel. As shown, in the illustrated embodiment, the recessed area 100 can be generally rectangular and positioned at or near the center of the seat portion 32. Further, the recessed area 100 covers at least half of the top surface of the seat portion 32. For example, the recessed area encompasses approximately 50%, 55%, 60%, 65%, 70%, 75%, 80%, 85%, 90%, 95%, 100% or ranges between such values of the top surface area of the seat portion 32. The “top surface area” of to the area of the seat surface (back or seat) that is typically contacted by the user. In the illustrated embodiment, the recess area 100 advantageously does not include sub-channels or small passages that extend from a common opening or plenum.

According to some embodiments, a climate controlled seat assembly includes a cushion having an outer surface comprising a first side for supporting an occupant and a second side, the first side and the second side facing generally in opposite directions. The seat assembly further comprises one or more fluid passages extending from the first side to the second side of the cushion and a recessed area along the first side of the cushion, the recessed area being in fluid communication with the fluid passage. In addition, the seat assembly includes a spacer positioned within the recessed area, the spacer being at least partially fluid permeable and being configured to substantially retain the spatial integrity of the recessed area. In some embodiments, the recessed area comprises a depth between 5 and 15 mm. In other arrangements, the depth of the recessed area can be greater than 15 mm or smaller than 5 mm.

According to some arrangements, a climate controlled seat comprises a cushion having an outer surface comprising a first side for supporting an occupant and a second side, the first side and the second side facing generally in opposite directions. The seat further includes one or more fluid passages generally extending from the first side to the second side of the cushion, a recessed area along the first side of the cushion and a spacer positioned within the recessed area, the spacer being at least partially fluid permeable and being configured to substantially retain the spatial integrity of the recessed area. The recessed is in fluid communication with the fluid passage. In some arrangements, the recessed area comprises a width to depth ratio between 8 and 40. However, in other arrangements, the width to depth ratio is greater than 40 or less than 8.

In other embodiments, however, the recessed area 100 can have a different shape, size, dimensions, spacing, location, depth and/or any other characteristics. For example, the recessed area 100 can have a generally circular, oval, triangular, other polygonal, irregular or any other shape. Moreover, the recessed area 100 can cover approximately half or less than half of the total top surface area of the seat portion 32. For example, in some embodiments, the recessed area 100 encompasses approximately 5%, 10%, 15%, 20%, 25%, 30%, 35%, 40%, 45%, 50% or ranges between such values of the top surface area of the seat portion 32.

In some embodiments, a seat portion 32 can comprise two or more recessed areas 100 along its top surface 46. It will be appreciated that the size, shape, spacing, locations and other characteristics of such recessed areas 100 can vary, as desired or required by a particular application.

As illustrated in FIG. 1B, the recessed area 100 or wide channel formed within the top surface of the seat portion 32 and/or the backrest portion 34 can be relatively shallow or thin so that it does not extend very far into the respective seat cushion. However, in other embodiments, the recessed area 100 can be deeper than illustrated and discussed herein. In some embodiments, the depth of the recessed area 100 can vary between 6 mm (0.24 in) and 16 mm (0.63 in). In one embodiment, the recessed area 100 comprises a depth of approximately 10 mm (0.40 in). In other embodiments, however, the depth of the recessed area 100 can be greater than 16 mm, less than 6 mm and/or any value in between these depths.

In addition, the length, width and/or other dimensions of the recessed area 100 can vary as desired or required by a particular application. In one embodiment, the recessed area 100 comprises a width approximately between 140 mm (5.5 in) and 180 mm (7.0 in). For example, in one embodiment, the width of the recessed area is approximately 160 mm (6.3 in). Likewise, the length of the recessed area 100 can also vary. In some embodiments, the length of the recessed area 100 is approximately equal to its width. However, the length of the recessed area 100 can be greater or less than its width. The length and width can be based on one or more factors, such as, for example, the overall size of the seating assembly, the desired maximum and minimum fluid flow toward an occupant, the types and thicknesses of layers (e.g., covering materials) positioned on the seating assembly, whether the seating assembly includes a heating pad and/or the like.

In some embodiments, the length, width, depth, shape and/or other characteristics of the recessed area 100 can depend on the size, dimensions, shape and other properties of the one or more seat inserts to be positioned within the recessed area 100. The dimensions of the recessed area 100 can be selected, at least in part, by the location, number, shape, size and/or other details of the conditioning zones positioned within the seating assembly. For example, the recessed area 100, and thus, the corresponding inserts, spacers and/or other items positioned therein, may extend to or near the front of the seat portion (e.g., to deliver air or other fluid near the occupants thigh or leg region).

In some embodiments, a seat portion and/or seat back portion of a seating assembly can include one, two, three or more different recessed areas 100. For example, in the embodiment illustrated in FIG. 1C, the seat portion 32A includes two recessed areas 100A, 100B. As shown, the recessed areas 100A, 100B can be positioned adjacent to each other and can generally include a similar size, shape and/or other characteristics. However, it will be appreciated that the spacing, location along the surface 46A of the seat portion 32A, shape, dimensions and/or other details can vary. For instance, one recessed area 100A can be smaller or larger than another recessed area 100B. Further, one recessed area 100A can have a different length, width, depth, shape, orientation and/or any other characteristics than the other recessed area 100B. In addition, as discussed, a seat portion 32A can have more or fewer recessed areas 100A, 100B than illustrated and described herein.

For simplicity, the features and components of the various embodiments of the climate control systems disclosed herein are illustrated and discussed only with respect to the seat portion 32 of a seat assembly 30. However, it will be appreciated that such features and components can be incorporated into the seat back or backrest portion 34 of the seat assembly 30, either in lieu of or in addition to the seat portion 32.

In some embodiments, the recessed areas 100 can be created by removing (e.g., cutting) material from the top surface of the seat portion 32 and/or backrest portion 34. Alternatively, the seat portion 32 and/or backrest portion 34 can be manufactured with the recessed areas 100 already formed therein. For example, in some arrangements, the foam material of the seat portion 32 can be molded (e.g., injection molded, compression molded, etc.) or otherwise formed to include one or more recessed areas 100 extending across its top surface 46.

With continued reference to FIG. 1B, the recessed area 100 is preferably in fluid communication with a fluid inlet 120 or similar passage. In some embodiments, the fluid inlet 120 extends completely or partially through the body of the seat bottom 32. The inlet 120 can then be in fluid communication with a fluid module, fan or other fluid transfer device to deliver a volume of air or other fluid to the recessed area of the seat portion 32. As is discussed in greater detail herein, the air or other fluid being delivered to the recessed area 100 can be unconditioned (e.g., ambient) and/or conditioned (e.g., heated, cooled, etc.). In some embodiments, the fluid module, fan, other fluid transfer device or the like can comprise or be in fluid communication with a thermoelectric device (TED), such as, for example, a Peltier device, in order to provide the necessary cooling and/or heating to the air or other fluid being conveyed. In other embodiments, a heating element (e.g., a resistive heating element) can be positioned downstream or upstream of the fluid module. In such an embodiment, the heating element can be activated along with the fluid module to provide heated air to the inlet 120 and in a second mode the fluid module can be activate alone to provide a cooling affect as unconditioned air is transferred to the inlet 120. For additional information regarding the use of heating elements to selectively heat air other fluids being conveyed in a climate control system for a seating assembly, see U.S. patent application No. 11/087,215, filed Mar. 23, 2005 and published as U.S. Publication 2006/0214480, the entirety of which is hereby incorporated by reference herein.

With continued reference to FIG. 1B, the seat portion 32 comprises a spacer fabric 108 that is configured to fit within the recessed area 100. In some embodiments, the spacer fabric 108 is configured to generally retain its three-dimensional shape when subjected to compressive and/or other types of forces. The spacer fabric 108 can advantageously include internal pores or passages that permit air or other fluid to pass therethrough. For example, the spacer fabric 108 can comprise an internal lattice or other structure which has internal openings at least partially extending from the top surface to the bottom surface of the spacer fabric 108. The spacer fabric 108 can be manufactured from one or more durable materials, such as, for example, foam, plastic, other polymeric materials, composites, ceramic, rubber and/or the like. The rigidity, elasticity, strength and/or other properties of the spacer fabric can be selectively modified to achieve the desired balance between comfort and durability. In some embodiments, the spacer fabric 108 can comprise woven textile, nylon mesh material, reticulated foam, open-cell foam and/or the like. The spacer fabric 108 can be advantageously breathable, resistant to crush and air permeable. However, in other embodiments, a spacer fabric 108 can be customized to suit a particular application. Therefore, the breathability, air permeability and/or crush resistance of a spacer fabric 108 can vary.

With continued reference to FIG. 1B, the spacer fabric 108 can be sized and shaped to generally match the size and shape of the recessed area 100. However, in other embodiments, the size and shape of the spacer fabric 108 can vary from that of the recessed area 100. In certain embodiments, the two or more different spacer fabrics 108 can be used in a single recessed area 100. The spacer fabric 108 can also comprise one, two or more different layers, as desired or required by a particular application.

As illustrated in FIG. 1B, a scrim layer 112 can be positioned on top of the spacer fabric 108. In some embodiments, the scrim layer 112 includes a plurality of openings 114. In the depicted embodiment, the scrim layer 112 comprises a total eight circular openings 114 which are generally aligned along two linear lines. In other embodiments, however, the number, size, shape, position, spacing, distribution and other characteristics of the openings 114 in the scrim layer 112 can be varied, as desired or required by a particular application. For example, the scrim layer 112 can be configured to have only a single opening 114, fewer than eight openings 114 or greater than eight openings 114.

In certain embodiments, the scrim layer 112 is manufactured from one or more materials that prevent or reduce air permeability through it. Thus, air or other fluid can pass across the scrim layer 112 generally only through openings 114. The openings 114 are preferably configured to distribute air or other fluid to the exterior surface of the seat and/or the backrest portions 32, 34 in a desired manner. The scrim layer 112 can be advantageously sized to match the dimensions of the recessed area 100. This can help prevent air or other fluid from escaping the recessed area 100 along the edges of the scrim layer 112. However, the area of the scrim layer 112 can be smaller than the area of the recessed area 100. In some embodiments, a recessed area 100 can include two or more different scrim layers 112.

The use of a scrim layer 112, as well as a spacer fabric 108 and any other layers can help prevent read-through. For example, the recessed areas 100 and any materials placed therein can be preferably sized, shaped and otherwise configured to provide a smooth, continuous feel to an occupant. Thus, in some embodiments, the spacer fabric 108 and/or the scrim layer 112 can be sized, shaped and otherwise configured to snugly fit within the recessed areas of a seat assembly. This can help provide desired transitions between the different materials and layers used in a climate-controlled seat assembly. In addition, the firmness, density, overall feel and other characteristics of the various components of the seat assembly, such as, for example, the scrim layer, the spacer fabric, other items positioned within a recessed area, the adjacent materials of the cushion and/or the like, can be advantageously selected to prevent read-through and enhance an occupant's comfort level when seated on the seating assembly.

The scrim layer 112 can be fluid permeable, impermeable or substantially impermeable, as desired or required by a particular application. In some embodiments, the scrim layer 112 comprises a relatively thick impermeable or substantially impermeable layer, such as, for example, foam, other polymeric material and/or the like. Alternatively, the scrim layer 112 can include a relatively thin layer of polymeric, fabric, foam and/or other material.

According to some embodiments, the scrim layer 112 and the adjacent spacer fabric can be joined to each other prior to insertion into the recessed area 100. Alternatively, the scrim layer 112 can be integrated into a covering fabric or other material that is placed along the exterior of the recessed area 100 and the seat portion 32. However, as discussed in greater detail herein with respect to other embodiments, the scrim layer and/or spacer fabric 108 can comprise a different configuration, as desired or required.

With continued reference to FIG. 1B, the recessed area 100 can optionally include one or more film layers 104 position between the lower surface of the recessed area 100 and the spacer material 108. As shown, the film layer 104 can be configured to generally match the size and shape of the recessed area 100. In some embodiments, the film layer 104 is attached to the bottom surface 102 of the recessed area 100 using adhesives, staples, clips, other fasteners and/or any other methods or device. Alternatively, the film layer 104 can be placed on top of the bottom surface 102 of the recessed area 100 without any separate securement method or device. In other embodiments, the film layer 104 comprises a coating or spray applied to the bottom surface 102 of the recessed area 100.

According to some embodiments, the film layer 104 is configured to completely or partially prevent air or other fluids from passing through it. The film layer 104 can be manufactured from one or more flexible or non-flexible materials, such as, for example, plastic, other polymeric or synthetic materials and/or the like. Thus, when placed within the recessed area 100, the film layer 104 helps prevent or reduce the passage of air or other fluid through the bottom surface 102. This can help increase the volume of air or other fluid that is transferred to the exterior surfaces of the seating assembly 30 and reduce any undesirable fluid losses.

In some embodiments, one or more film layers 104 can be used to cover both the bottom and side surface of the recessed area 100. Such an optional film layer 104 can be included as a part of the foam assembly (e.g., an exterior and/or interior surface of the cushion into which the recessed area is formed). For example, a film layer 104 can be applied to the foam assembly as a spray, coating, film and/or the like. Alternatively, the film layer 104 can be formed with or joined to the spacer fabric 108. In still other embodiments, the film layer 104 can be a separate member that may or may not be joined to any other portion or component of the seating assembly 30.

It will be appreciated that one or more film layers can be used with any of the embodiments illustrated and/or discussed herein or equivalents thereof. As discussed, the film layer can help reduce or prevent fluid losses in undesirable directions (e.g., through the bottom or sides of the foam assembly), and thus, may help increase the fluid flow directed toward an occupant.

In certain embodiments, the spacer fabric 108, the scrim layer 112 and/or the film layer 104 are configured to completely fill the recessed area 100 when positioned therein. Thus, the top surface 46 of the cushion can be relatively smooth. After the spacer fabric 108, the scrim layer 112 and/or the film layer 104 have been positioned within the recessed area 100, one or more layers of fabric or other covering material can be placed on the outside of the seat portion 32. As discussed, such a covering material can provide an aesthetic appearance and/or a soft feel to the surface of the seat assembly 30. In addition, the covering material can hide the recessed area 100 and the various components placed therein.

Likewise, as illustrated in FIG. 1C, separate film layers 104A, 104B, spacer materials 108A, 108B and/or scrim layers 112A, 112B can be positioned in each recessed area 100A, 100B. Further, each recessed area 100A, 100B can comprise its own fluid inlet 120A, 120B that is in fluid communication with one or more fluid modules (e.g., blowers, fans, other fluid transfer devices, thermoelectric devices, etc.). In some embodiments, a single fluid transfer device can be configured to deliver air or other fluid to both recessed areas 100A, 100B. However, in other embodiments, each recessed area 100A, 100B can comprise one or more dedicated fluid transfer devices.

As with other embodiments discussed and illustrated herein, each of the scrim layers 112A, 112B in FIG. 1C can include a plurality of openings 114. In the depicted embodiment, each scrim layer 112A, 112B comprises a total three circular openings 114 which are generally aligned along two linear lines. In other embodiments, however, the number, size, shape, position, spacing, distribution and/or other characteristics of the openings 114 in the scrim layer 112A, 112B can be varied, as desired or required by a particular application. For example, the scrim layer 112A, 112B can be configured to have only a single opening 114.

In other embodiments, regardless of the number of recessed areas a particular seating assembly comprises, the scrim layer 112 is generally permeable or porous. Thus, a scrim layer 112 can be configured to allow air or other fluid to flow across it, generally toward an occupant, either in lieu of or in addition to having a plurality of larger openings 114.

The use of two or more recessed areas 100A, 100B in a seat assembly can facilitate the delivery of fluids (e.g., heated or cooled air) to more targeted locations of the seating assembly. For example, it may be desirable to target the regions of the seat portion and/or the seat back portion with which an occupant is likely to make contact.

FIG. 3 is a schematic illustration of one embodiment of a climate control system 36 for a seating assembly 30. The illustrated fluid module 200 and the downstream fluid distribution system 202 with which the fluid module 200 is in fluid communication are situated within a seat portion 32 of the seat assembly 30. The backrest 34 can include similar climate control features and components, either in lieu of or in addition to the seat portion 32.

As discussed, the fluid module 200 can be configured to direct either ambient or thermally conditioned (e.g., heated, cooled, etc.) air or other fluids to a top surface 48 of the seat portion 32 and/or backrest portion 34 of the seat assembly 30. Specifically, the climate control system can be configured to provide conditioned air that is either heated or cooled relative to the temperature of the exterior surfaces of the seating assembly 30. In other embodiments, unconditioned fluid (e.g., ambient air) is directed to the exterior surfaces of the seating assembly 30 to provide a cooling effect.

In other embodiments, the fluid module 200 is configured to provide ambient (e.g., unconditioned) air to one or more exterior surfaces of the seating assembly 30. Thus, the fluid module 200 can be used to simply ventilate the seating assembly 30. In other embodiments, a user can selectively control whether to provide unconditioned or conditioned air to the seating assembly 30. Further, a seating assembly 30 can be advantageously configured to permit a user to selectively control the temperature, flowrate and/or other properties of the air or fluid delivered by the fluid module 200.

With continued reference to the embodiment illustrated in FIG. 3, the fluid module 200 includes a thermoelectric device 204 for temperature conditioning (e.g., selectively heating and/or cooling) air or other fluid flowing through or past the device 204. In some embodiments, the thermoelectric device 204 is a Peltier thermoelectric module. The illustrated fluid module 200 can also include a main heat exchanger 214 for transferring heat to or from the fluid that flows through or past the module 200 and the downstream fluid distribution systems 202. The fluid module 200 can also preferably include a secondary heat exchanger 216. Such a secondary heat exchanger 216, which can be positioned generally opposite of the main heat exchanger 214, can be used to waste or absorb heat as needed. In some embodiments, a fluid module 200 can simply comprise a fluid transfer device that is configured to deliver thermally unconditioned fluid (e.g., ambient air) toward an occupant. Thus, the fluid module 200 can be used to simply ventilate a seating assembly.

Further, as schematically illustrated in FIG. 3, each fluid module 200 can comprise one or more fluid transfer devices 206. Such fluid transfer devices 206 can be used to convey air or other fluid through or past the main and/or waste heat exchangers 214, 216. The fluid transfer device 206 can comprise an electrical fan or blower, such as, for example, an axial blower and/or radial fan. In the illustrated embodiment, a single fluid transfer device 206 can be used to move air or other fluid past, near or through both the main and waste heat exchangers 214, 216. However, in other embodiments, separate heat transfer devices may be associated with the secondary and heat exchangers 214, 216.

The fluid module 200 described herein represents only one exemplary embodiment of a device that may be used to condition air or other fluid supplied to the downstream distribution system 202. Alternatively, differently configured fluid modules may be used to provide conditioned and/or unconditioned fluid to one or more portions of the seating assembly. Other examples of fluid modules that may be used are described in U.S. Pat. Nos. 6,223,539, 6,119,463, 5,524,439 or 5,626,021, which are hereby incorporated by reference in their entirety. Another example of such a fluid module is currently sold under the trademark Micro-Thermal Module™ by Amerigon, Inc. In another example, the fluid module comprises a fluid transfer device without a thermoelectric device for thermally conditioning the air. In such embodiments, the fluid transfer device can be used to remove or supply air to the distribution system 202. In yet other embodiments, the fluid module 200 is configured to share one or more components (e.g., fluid transfer devices, thermoelectric devices, etc.) with a vehicle's general climate control system (e.g., a vehicle's HVAC system). In one arrangement, the fluid module includes a fluid transfer device that delivers air to a heating element (e.g., a resistive element) that is positioned along the flow path between the fluid module 200 and the recess 100. In one mode of operation, the heating element is activated along with the fluid module 200 to selectively heat air being delivered to the occupant. In a second mode, the fluid module 200 can be operated alone to provide a cooling function as unheated air is supplied to the occupant.

With continued reference to the schematic illustration of FIG. 3, air or other fluid is delivered by one or more fluid transfer devices 206 through or past a thermoelectric device 204 to selectively cool or heat the air or other fluid. The conditioned air or other fluid is then conveyed into recessed area 100 of the seat portion 32, via the fluid inlet 120. Next, the air or other fluid passes through the spacer fabric 108 towards the scrim layer 112. As discussed, the spacer fabric 108 is preferably configured to prevent the recessed area 100 from collapsing when forces are exerted thereon. For example, in some embodiments, the spacer fabric 108 is advantageously configured to resist any anticipated downward forces imposed on the seat portion by a seated occupant.

After the air or other fluid passes through the spacer fabric 108, it may encounter a scrim layer 112. As discussed, the air or other fluid can pass across the scrim layer 112 through one or more openings 114. Air or other fluid conveyed through the openings 114 of the scrim layer 112 may be distributed through one or more covering layers toward the seat occupant.

As discussed with reference to FIG. 1B, one or more film layers 104 can be positioned along the bottom surface 102, side surfaces and/or any other portion of the recessed area 100 to prevent air or other fluids from passing through the cushion of the seat portion 32. It will be appreciated that the features and components of a climate control system schematically illustrated in FIG. 3 and discussed herein can be incorporated into the seat back portion 34 of a seat assembly, either in lieu of or in addition to the seat portion 32.

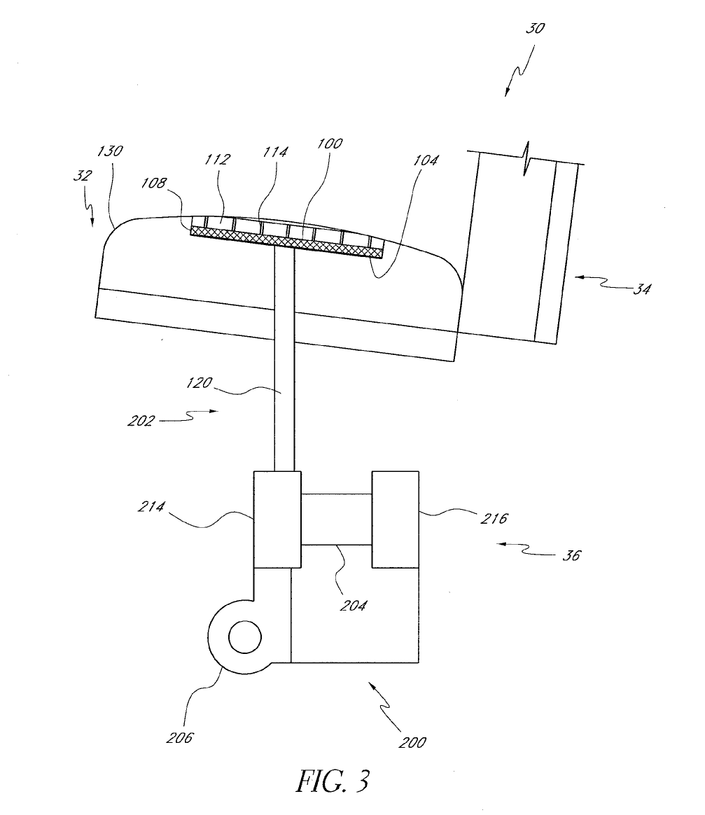

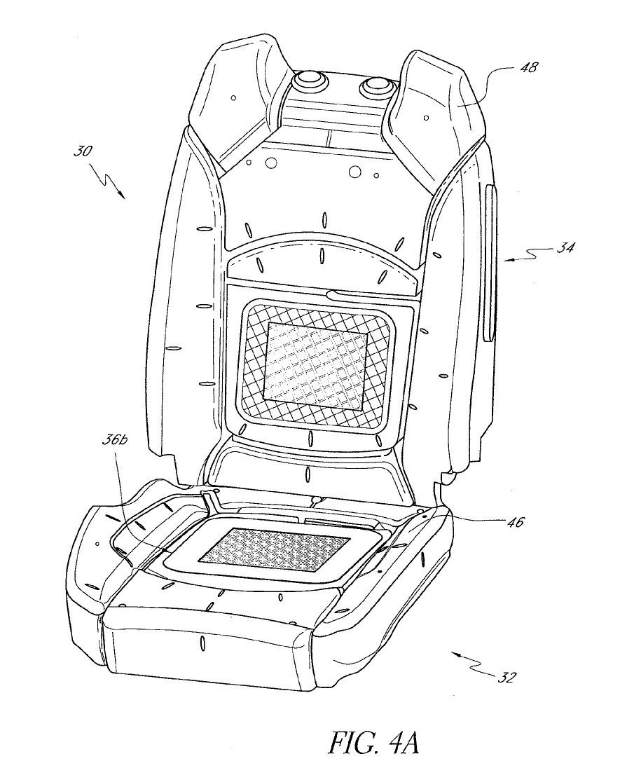

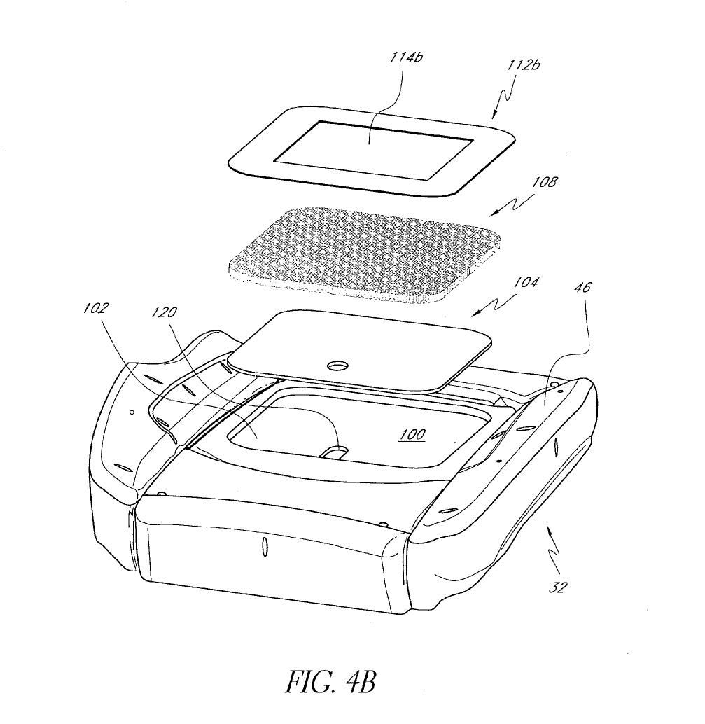

In FIGS. 4A and 4B, the seat portion 32 of a seating assembly 30 includes a climate control system 36b according to another embodiment. Similar to other embodiments disclosed herein, the illustrated seat portion 32 includes a recessed area 100 or a wide channel that is configured to receive a spacer fabric 108, a scrim layer 112b and/or a film layer 104. The illustrated scrim layer 112b includes one large center opening 114b instead of a plurality of openings as depicted in FIG. 1B. Thus, as air or other fluid passes through the spacer fabric 108, it is generally directed through the relatively large opening 114b located toward the center of the scrim layer 112b. Accordingly, air or other fluid passing through the scrim layer 112b can be delivered through one or more layers (e.g., foam, covering layer, etc.) towards a seated occupant.

Such a window-style scrim layer 112b with a relatively large interior opening 114b can allow for a distributed conditioned zone to be created along the corresponding exterior surface of the seat portion 32 and/or backrest portion 34 of the seating assembly 30. Thus, in such embodiments, the scrim layer 112b can help mask the transition between the foam or other material surrounding the recessed area 100 and the spacer fabric 108 positioned underneath the scrim layer 112b.

In other embodiments, the openings 114b in the scrim layer 112b can be differently configured than illustrated in FIGS. 4A and 4B. For example, the opening 114b can have a different shape, size, location, position, orientation and/or any other characteristics. In addition, two or more relatively large openings 114b can be included in a scrim layer 112b.

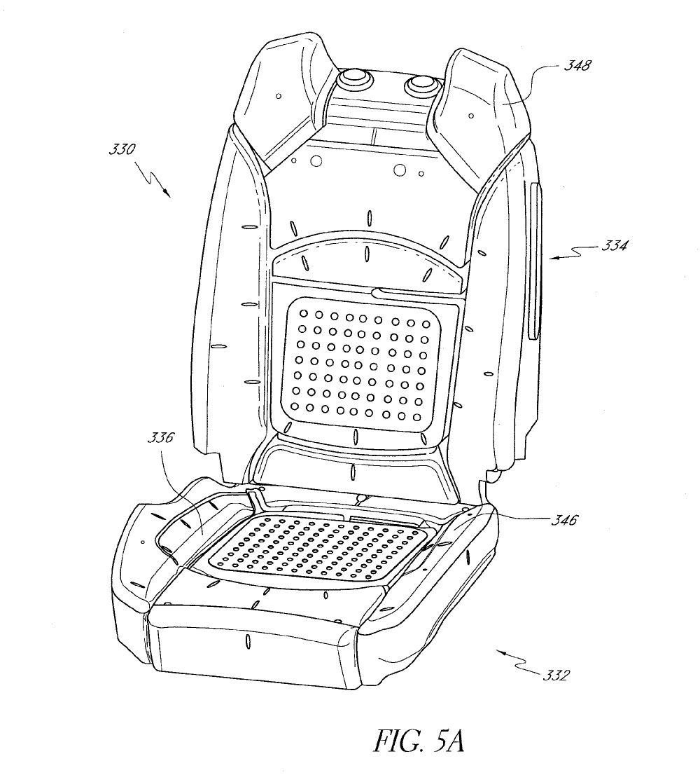

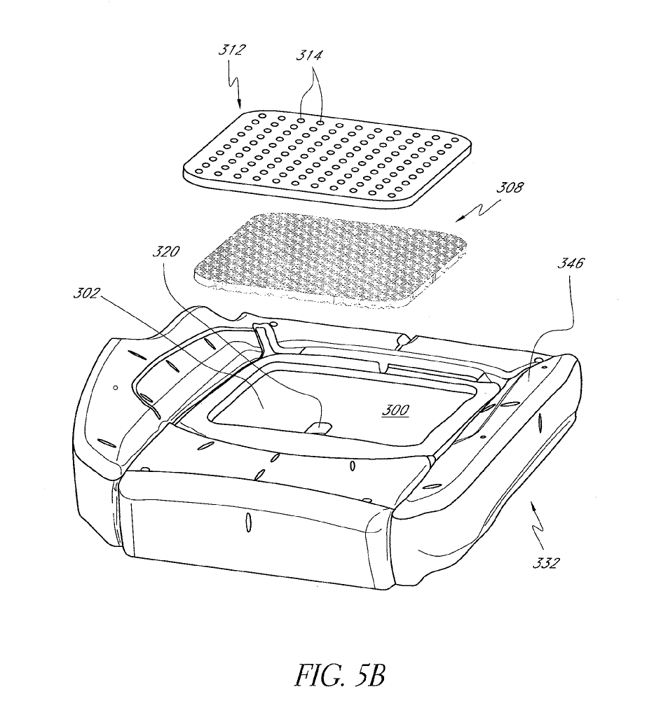

With reference to FIGS. 5A and 5B, the seat assembly can include one or more padding or comfort layers 312 that include a plurality of circular openings 314 through which air or other fluid may pass. Similar to other embodiments discussed and illustrated herein, air or other fluid entering the recessed area 300 or wide groove area of the seat portion 332, may pass through the spacer fabric toward the comfort layer 312. The number of openings 314 in the padding layer 312 can vary depending on the type of fluid distribution desired or required for a particular application. According to some embodiments, in addition to being configured to distribute air or other fluid toward a seat assembly occupant, the padding layer 312 can enhance an occupant's comfort level. For example, the padding layer 312 can comprise the necessary materials and/or configuration to provide a cushioning effect for a seat assembly occupant. In some embodiments, the thickness of the padding or comfort layer 312 may be selected to further augment the feel to an occupant.

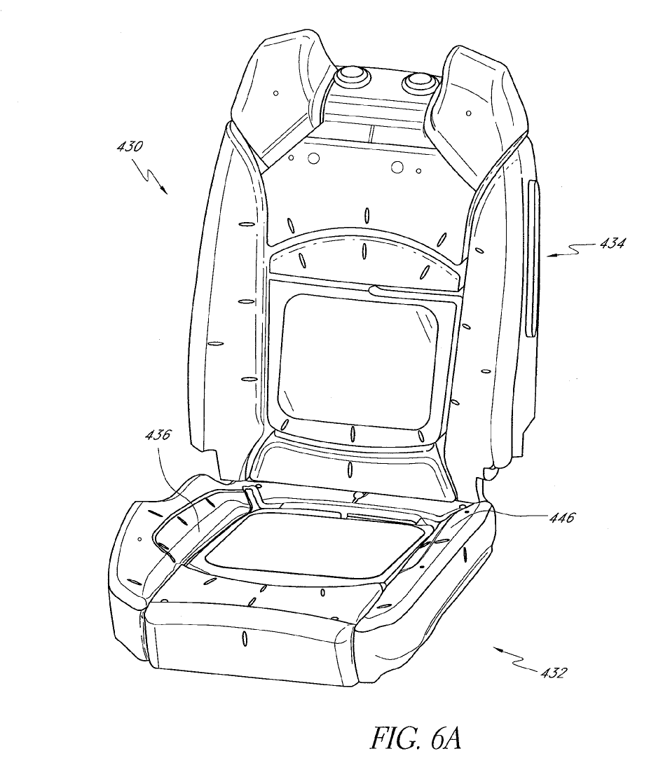

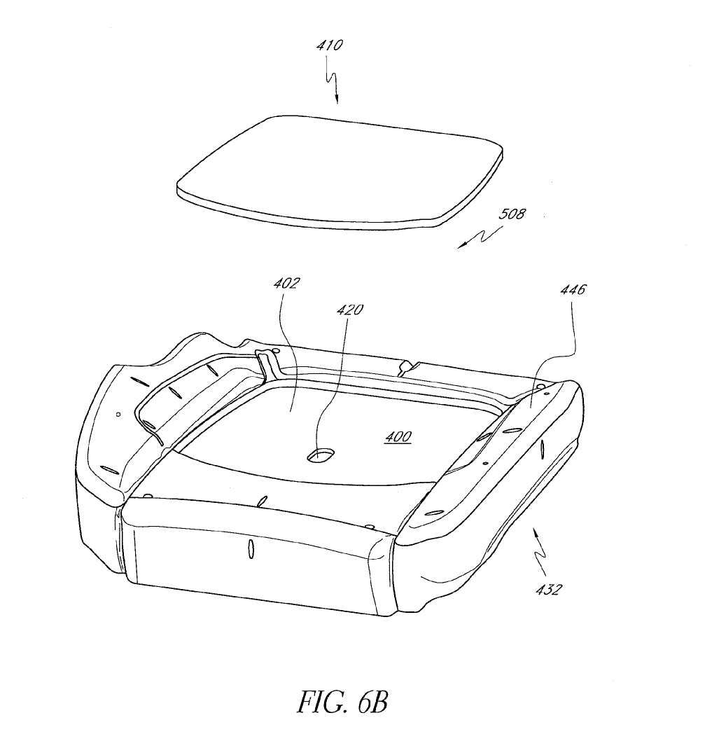

With reference to the embodiment illustrated in FIGS. 6A and 6B, the seat portion 432 can include a recessed area 400 or a wide groove area which is in fluid communication with one or more fluid inlets 420. As discussed herein with respect to other embodiments, conditioned and/or unconditioned air can be conveyed into the recessed area 400 through the fluid inlet 420. A spacer fabric 410 can be positioned within the recessed area 400. In some embodiments, the spacer fabric 410 is shaped, sized and otherwise configured to fit generally snugly within the recessed area 400. Alternatively, however, the spacer fabric 410 may be configured to fit more loosely within the recessed area 400.

As discussed with respect to other embodiments, the spacer fabric 410 can be configured to maintain the integrity of the recessed area 400 when forces are exerted on the seat assembly 430. In some embodiments, the spacer fabric 410 is air permeable or substantially air permeable to permit air or other fluids entering the recessed area 400 to pass through it. Thus, ambient, heated, cooled and/or otherwise conditioned air or other fluid can be advantageously directed toward the top surface of the 446 of the seat portion 432. It will be appreciated that a similar fluid distribution system can be included in the backrest portion 434 of the seating assembly 430, either in lieu of or in addition to the seat portion 432.

In some embodiments, as illustrated in FIG. 6B, the recessed area 400 of a seat portion 432 or a backrest portion 434 is configured to receive only a spacer fabric 410. In other embodiments, however, one or more other components may be placed within the recessed area 400 to further enhance the fluid transfer properties of the seating assembly 430. For example, as discussed with respect to other arrangements, a scrim layer, a film layer, a comfort layer and/or any other layer can be placed on either side of the spacer fabric 410. It will be appreciated that the exact order of various components placed within a recessed area 400 can be varied as desired or required by a particular application.

With continued reference to FIG. 6B, once air or other fluid is transferred into the recessed area 400 through the fluid inlet 420, it may be conveyed across the body of the spacer fabric 410. Therefore, such air or other fluid can be distributed through the spacer fabric 410 and toward the top surface 446 of the seat portion 432. The air or other fluid can pass through one or more additional layers (e.g., covering materials, foam layers, scrim layers, comfort layers, etc.) before ultimately reaching an occupant situated within the seating assembly 430. By eliminating the need for a separate scrim layer, a film layer and/or the like, the depicted embodiment can facilitate the manufacturing and/or assembly of a climate controlled seat assembly 430.

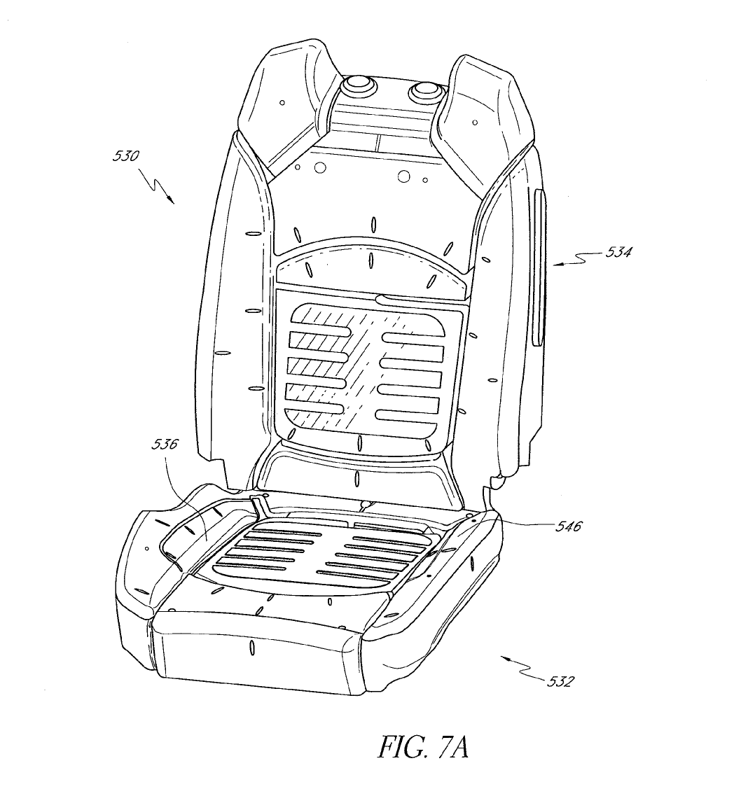

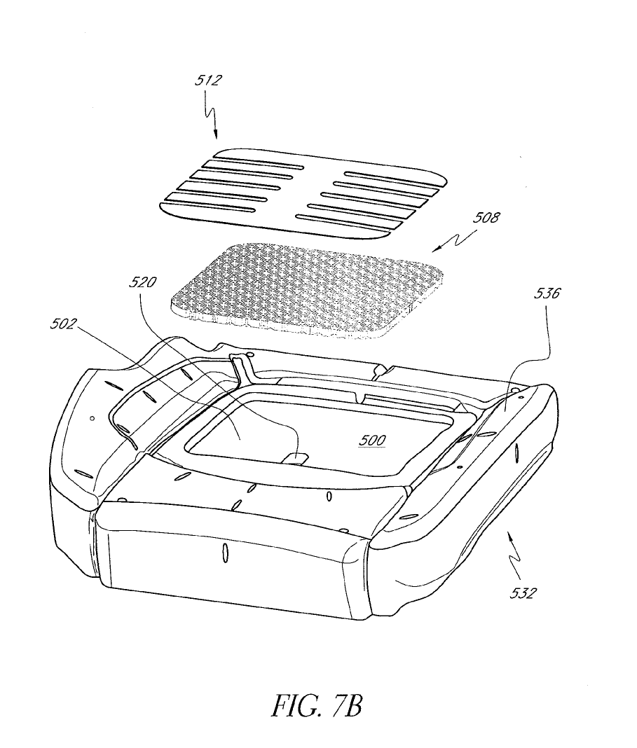

Another embodiment of a climate controlled seating assembly 530 is illustrated in FIGS. 7A and 7B. As shown, the recessed area 500 of the seat portion 532 can be configured to receive a spacer fabric 508 and a heat mat 512. The heat mat 512 can comprise a plurality of slits 514 or other openings across its surface. Further, the scrim layer 512 can be configured to permit air or other fluid to pass across it only or predominantly through such slits 514. The depicted arrangement comprises a total of ten slits 514, which are generally parallel to one another and are positioned along the outer edges of the heat mat 512. However, the size, shape, position, orientation, spacing and/or other characteristics of the heat mat 512 or other heating device can be different than illustrated and discussed herein.

The heat mat 512 can include flexible electrical heating elements that can be generally thin, flat, and/or otherwise non-obtrusive. For example, the heat mat 512 can comprise a lay-wire heater, a carbon fiber heater, a positive thermal coefficient (PTC) heater, a thermoelectric heater or the like, which can be supported a backing substrate (e.g., a cloth or fabric type backing) may form the heat mat 512. In other embodiments, a heat layer is integrated with the spacer fabric using one or more attachment methods. For example, the heat layer and the spacer fabric can be joined using adhesives, mechanical bonding, melt bonding, clips, other fasteners, interlacing and/or any other connection method or device. In other embodiments, a heat layer and a spacer fabric can be joined by passing or otherwise arranging the strands or other portions of a heater (e.g., wire heater, carbon fiber heater, PTC, etc.) through the spacer fabric. In some embodiments, one or more strands of a conductive heating wire can be weaved or otherwise integrated or incorporated directly into a spacer fabric material.

In FIG. 7B, as with other embodiments that include a scrim layer, the heat mat 512 can be configured to be non-air permeable or partially-air permeable to fluid flow. This can permit air or other fluid to be transferred across the heat mat 512 only or predominantly through the slots 514, slits or any other openings. Consequently, the flow distribution of conditioned or unconditioned fluid towards a seated occupant can be advantageously controlled. However, the quantity, shape, size, spacing, location, configuration and/or other details of the openings can be different than illustrated and discussed herein.

The seat assembly illustrated in FIG. 8 is substantially similar to the embodiment of FIGS. 1A and 1B. As shown, the recessed area 600 of the seat portion 632 can include pockets 602A, 602B or other protruding areas that are configured to extend the conditioning and/or ventilation zones to target specific regions of the seat assembly. With reference to the embodiment depicted in FIG. 8, the seat portion 632 includes two pockets 602A, 602B that extend toward the front of the seat assembly, generally underneath where an occupant's thighs or upper legs would be normally positioned. Consequently, a fraction of the air or other fluid that enters the recessed area 600 can move towards the pockets 602A, 602B. As in the main portion of the recessed area 600, air or fluid can then move toward an occupant through one or more layers, such as, for example, a spacer fabric 608, 610, a scrim layer 612, 618, a covering material, a heating layer, a comfort layer and/or the like. In the illustrated embodiment, the pockets 602A, 602B are generally coextensive with the recessed area 600. Alternatively, however, the pockets 602A, 602B can be non-coextensive with and separate from the recessed area 600. It will be appreciated that the features and components of a climate control system disclosed herein with reference to FIG. 8 can be incorporated into the seat back portion (not shown) of a seat assembly, either in lieu of or in addition to the seat portion 632. Accordingly, a seat back portion can include a recessed area having one or more pockets 602A, 602B or other protruding areas.

With continued reference to FIG. 8, each of the pockets 602A, 602B can be configured to receive a film layer 606 on its bottom surface, a spacer fabric 610, and a scrim layer 618. In FIG. 8, these layers are illustrated in exploded view only for a single pocket 602A. However, it will be appreciated that another set of such layers, or any other combination of layers, can be positioned in the other pocket 602B.

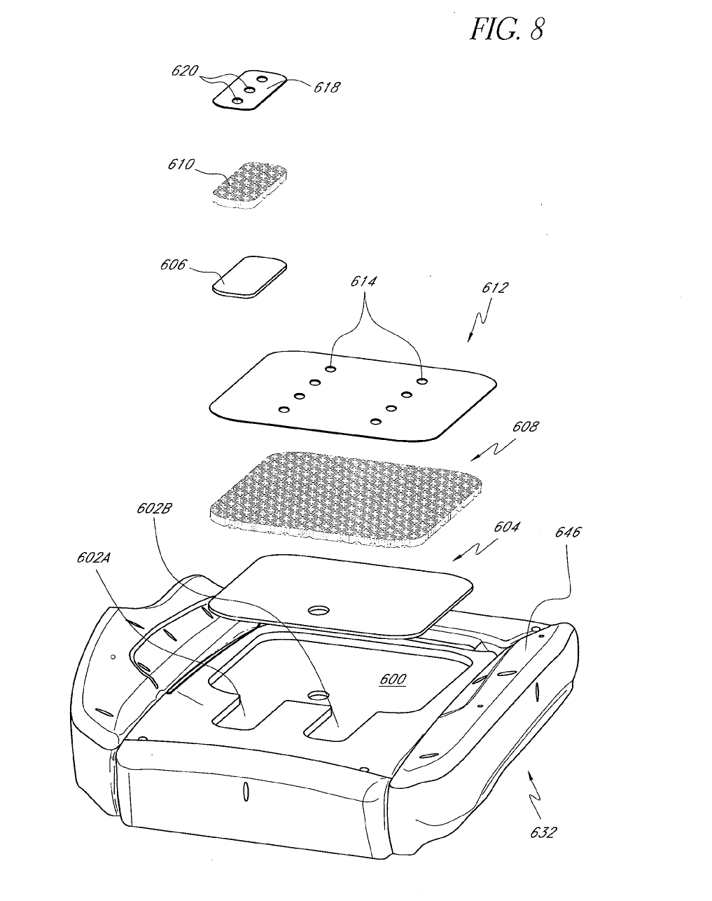

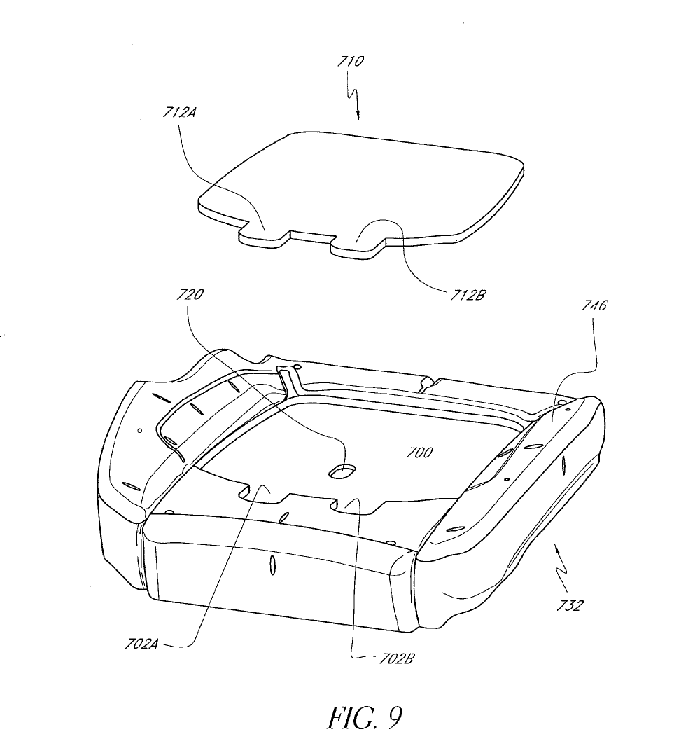

In other embodiments, the film layer 604, spacer fabric 608, scrim layer 612, heat layer, comfort layer and/or other layers can be sized, shaped or otherwise configured to fit within the entire recessed area 600, including one or more pockets 602A, 602B that a recessed area 600 may include. For example, in FIG. 8, the film layer 604, the spacer fabric 608 and the scrim layer 612 may include two extensions on one of their sides to snugly fit within the recessed area 600 of the illustrated seat portion 632 Likewise, as illustrated in the embodiment of FIG. 9, the spacer fabric 710 can include two extensions 712A, 712B which are configured to fit within the corresponding pockets 702A, 702B of the recessed area 700.

In some embodiments, a seating assembly includes more or fewer conditioning or ventilation pockets than illustrated and discussed herein. In addition, such pockets can be positioned in one or more other areas of a seat portion and/or a seat back portion of a seating assembly. For example, a seat back portion can include pockets that extend the conditioning (e.g., heating, cooling, etc.) and/or ventilation zones toward an occupant's neck or shoulders. As discussed and illustrated herein, the layers that fit within the recessed area having such pockets can be a single unitary member or may comprise two or more separate portions.

Such pockets 602A, 602B, 702A, 702B can help expand the areas of a seating assembly to which conditioned and/or unconditioned air is delivered. Consequently, a user's comfort level can be enhanced without having to use larger recessed areas throughout the seat portion and/or seat back portion of a seating assembly. In some embodiments, the seat assembly can be configured to permit an occupant to selectively control which and to what extent (e.g., temperature, flowrate, etc.) pockets are activated at any particular time.

In other embodiments, a seat portion and/or seat back portion includes one or more conditioning or ventilation pockets that are not in fluid communication with a main recessed area. For example, such pockets can include their own inlets for receiving air or other fluid from one or more fluid transfer devices. In one embodiment, a pocket includes its own inlet and is in fluid communication with a main recessed area. Thus, a user can selectively regulate the level of conditioning and/or ventilation to a particular region of the seating assembly by controlling the flowrate, temperature and/or other characteristics of the fluid entering the pocket via the pocket's own inlet.

In other embodiments, one or more conditioning and/or ventilation pockets are not coextensive or non-continuous with a main recessed area. Thus, such pockets can be placed in fluid communication with a main recessed area, or with each other, using one more fluid channels or conduits. For example, a pocket situated near the thigh region of the seat portion or the neck region of the seat back portion can be completely separate from the main recessed area. In order to deliver conditioned and/or unconditioned (e.g., ambient air) to such pockets, a fluid channel or other conduit (e.g., tubing, passageway, etc.) can be positioned within the cushion or other portion of the seating assembly. In other embodiments, one or more pockets are in fluid communication with a recessed area using channels or other conduits positioned within the cushion of and/or on the back side of the seat portion and/or the seat back portion. Alternatively, the pockets can comprise their own inlets which are in fluid communication with one or more fluid modules or fluid transfer devices.

In still other embodiments, one or more regions of the seating assembly are targeted for additional or supplemental conditioning or ventilation by incorporating other types of the fluid delivery and distribution systems into the seat portion and/or seat back portion. For example, air or other fluids can be delivered into one or more fluid channels or recessed areas incorporated into the back side of the seat portion and/or the seat back portion. Such channels or recessed areas can include a plurality of orifices and/or one or more air permeable surfaces to permit the air or other fluid to be transferred to the front side of the seating assembly, generally in the direction of a seated occupant. Such channels or recessed areas on the back surfaces of the seat portion and/or seat back portions can be sized, shaped, located, oriented and/or otherwise adapted to target specific portions of an occupant's body (e.g., thigh, lower back, neck, other contact surfaces, etc.).

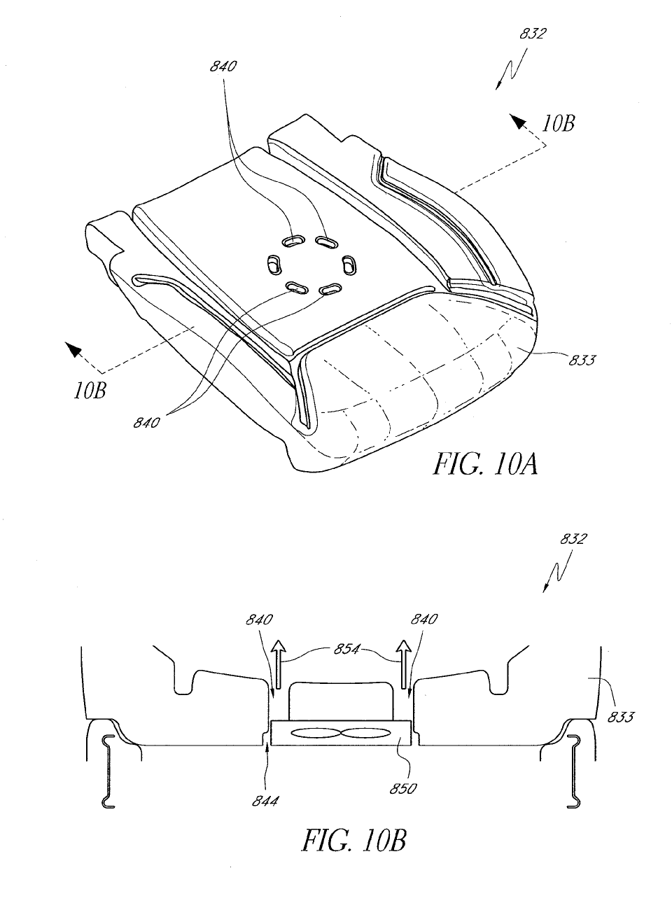

FIGS. 10A and 10B illustrate another embodiment of a seat bottom portion 832 of a seat assembly being configured to transfer ambient and/or thermally conditioned air or other fluid toward and/or away from a seated occupant. As shown, the seat bottom portion 832 can include a plurality of holes 840 or other openings. In the depicted arrangement, there are six holes 840 are positioned at or near the center of the seat bottom portion 832. The holes 840 are oriented in a circular pattern and comprise a generally oval shape. However, in other embodiments, the quantity, size, shape, position, spacing and/or other details of the holes 840 or other openings can vary, as desired or required.

With reference to the cross-sectional view of FIG. 10B, the holes 840 can be configured to be in fluid communication with a cavity 844 or other region generally located on the opposite side of the seat cushion 833. As shown, a fluid module 850 can be positioned within such a cavity 844. In some embodiments, the fluid module 850 comprises a blower, fan or other fluid transfer device. The fluid module 850 can additionally include a thermoelectric device (e.g., Peltier device) or other component that is adapted to selectively heat and/or cool air or other fluid being transferred into or out of the holes 840. The fluid module 850 can be secured to the cushion 833 and/or any other portion of the seat assembly using clips, screws, other fasteners, adhesives and/or any other connection device or method.

Accordingly, air or other fluid may be selectively transferred through the holes 840 of the seat bottom portion 832, without the need for a spacer (e.g., spacer fabric or other material) or the like. As discussed, the fluid module 850 can be configured to deliver fluid toward (e.g., in a direction generally represented by arrow 854) and/or away from the top of the seat assembly. The holes 840 or other openings can be created when the corresponding portion of the seat assembly is being formed (e.g., using injection molding or other forming techniques). Alternatively, the holes 840 can be formed after the seat bottom portion or the seat back portion has been manufactured (e.g., by removing material from the cushion).

In some arrangements, one or more spacer assemblies (e.g., spacer material or fabric), films, scrims, comfort layers and/or any other members can be positioned within the holes 840. In addition, it will be appreciated that a seating assembly can include such a climate control system in the seat back portion, either in addition to or in lieu of the seat bottom portion 832. Further, a seat bottom portion 832 and/or a seat back portion can include two, three or more such climate control assemblies.

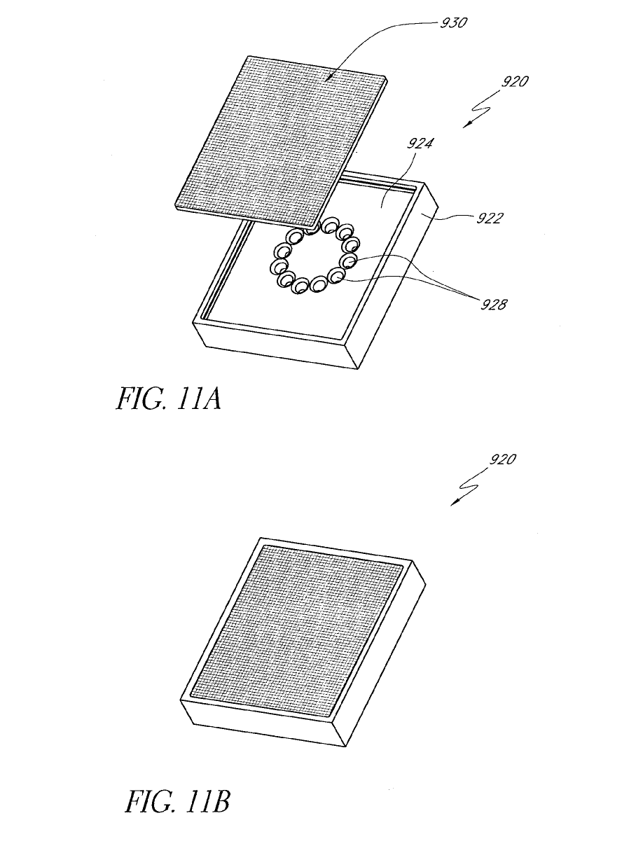

FIGS. 11A and 11B illustrate one embodiment of a spacer module 920 configured to be positioned within a recessed area of a seat bottom and/or seat back portion of a climate controlled seat assembly. As shown, the spacer module 920 can include a base portion 922 which may comprise a recessed area 924. In some embodiments, the recessed area 924 is generally defined by a lip or other protruding features generally positioned along the perimeter of the base portion 922. A plurality of holes 928 or other openings can be positioned within the recessed area 924 of the base portion 922. For example, in the depicted embodiment, a total of twelve holes 928 are positioned at or near the center of the recessed area 924 in a generally circular orientation. However, it will be appreciated that the quantity, shape, size, position, spacing and/or other details of the holes 928 can vary.

In the embodiment illustrated in FIGS. 11A and 11B, the recessed area 924 of the spacer module 920 can be sized, shaped and otherwise configured to receive one or more spacers 930 (e.g., spacer fabric or member) or other air-permeable materials. Thus, as air or other fluid is delivered through the holes 928 or other openings, it can be distributed into the spacer member 930. As discussed herein with reference to other arrangements, one or more scrim layers, comfort layers, covering layers and/or the like can be positioned on top of the spacer member 930. Such layers can be incorporated into the spacer module 930 or can be separate from it. Regardless, air or other fluid exiting the spacer member 930 may be configured to pass through such layers before being conveyed to a seated occupant.

A fluid module (not shown) can be positioned within the spacer module 920 (e.g., underneath the recessed area 924 of the base portion 922). Thus, ambient and/or conditioned (e.g., heated, cooled, etc.) air or other fluid can be delivered to or removed from the spacer material 930 through the holes 928 or other openings. Alternatively, the holes 928 or other openings can be in fluid communication with a fluid module (e.g., blower, fan, other fluid transfer device, etc.) that is not positioned within the spacer module 920. For example, the spacer module 920 can be placed in fluid communication with a fluid module located on the rear side of a seat back portion or underneath the seat bottom portion. The spacer module 920 illustrated in FIGS. 11A and 11B includes a generally rectangular shape. However, the module 920 can include any other shape depending on the characteristics of the recessed area into which it will be placed. The spacer module 920 can be secured within a recessed area of a seat back or seat bottom portion of a seat assembly using adhesives, clips, other fasteners and/or any other connection method or device.

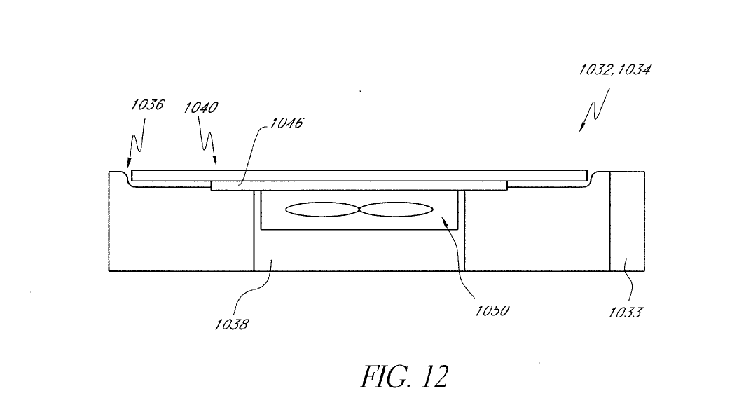

A cross-sectional view of another embodiment of a climate controlled seat assembly is illustrated in FIG. 12. As shown, the seat cushion 1033 of a seat bottom portion 1032 and/or a seat back portion 1034 can include an upper recessed area 1036 and a cavity 1038. A spacer module 1040 can be positioned within the upper recessed area 1036 of the cushion 1033. The spacer module 1040 can include a spacer fabric or other air permeable material configured to generally retain its structural integrity during use. In some embodiments, the spacer module may also include and/or may be attached to one or more other layers or members, such as, for example, films, scrims, comfort layers and/or the like.

With continued reference to FIG. 12, a fluid module 1050 can be positioned within the cavity 1038 of the seat bottom portion 1032 and/or the seat back portion 1034 of the seat assembly. In some arrangements, the fluid module 1050 includes a blower, fan, another fluid transfer device, a thermoelectric device (e.g., for selectively heating or cooling air or other fluid) and/or the like. The fluid module 1050 can be attached (e.g., removably or permanently) to the spacer module 1040 using one or more intermediate members 1046, fasteners, adhesives and/or any other connection device or method. Thus, the fluid module 1050 can be directly integrated into the spacer module 1040. Accordingly, in some arrangements, the spacer module 1040 and the fluid module 1050 can be positioned within the corresponding openings (e.g., the recessed area 1036, cavity 1038, etc.) of the seat assembly as a single structure. In one embodiment, the spacer module 1040 and the fluid module 1050 can be conveniently installed into the seat bottom portion 1032 and/or the seat back portion 1034 as single unit through the top and/or front side of the seat assembly. Alternatively, the spacer module 1040 and the fluid module 1050 can be separate members that are configured to be individually secured to the seat assembly.

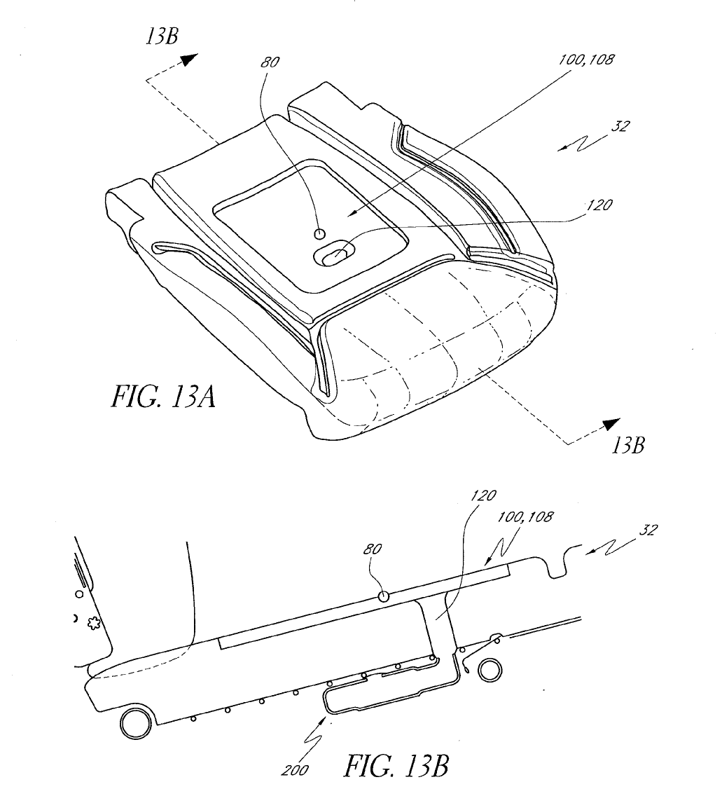

FIGS. 13A and 13B illustrate an embodiment of a climate controlled seat assembly comprising a temperature sensor 80. One or more temperature sensors 80 can be positioned at any location within or near a fluid stream. In the depicted embodiments, a single temperature sensor 80 is generally positioned within the recessed area 100 of the seat bottom portion 32. In other embodiments, a temperature sensor 80 can be included within one or more of the layers or members that are configured to be placed within the recessed area 100. For example, one or more sensors 80 can be positioned in or adjacent to a spacer 108 (e.g., spacer fabric or other member), a scrim layer, a comfort layer, a film and/or the like. Further, one or more temperature sensors 80 can be included within the fluid inlet 120 or at any other location of the seat assembly that may come in contact with air or other fluid being transferred by the fluid module 200 (e.g., an exterior surface of the seat assembly). Information received from such temperature sensors 80 can be transmitted (e.g., through hardwired or wireless connections) to a controller and/or to any other electrical component (e.g., fluid transfer device, thermoelectric device, other components of the fluid module 200, etc.) to advantageously maintain a desired cooling and/or heating setting. It will be appreciated that one or more temperature sensors 80 can be positioned within a fluid path of the seat back portion, either in lieu of or in addition to the seat bottom portion 32.

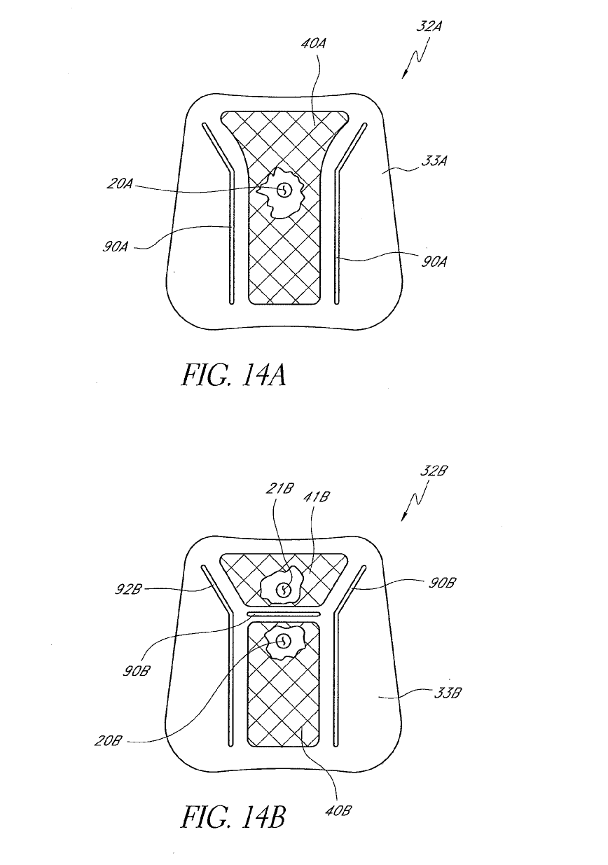

FIG. 14A illustrates one embodiment of a seat bottom portion 32A having a plurality of tie-down trenches 90A, which are configured to help attach a covering material (not shown) to the seat assembly. The depicted arrangement includes a spacer member 40A positioned within a recessed area of the seat bottom portion 32A. The recessed area, and thus the spacer member 40A positioned therein, are generally located between two tie-down trenches 90A. Accordingly, since the spacer member 40A is continuous and does not need to traverse across any tie-down trenches 90A and/or any other features, a single fluid inlet 20A can be used to supply air or other fluid to the recessed area and the spacer 40A positioned therein.

However, as illustrated in FIG. 14B, a seat bottom portion 32B can include a tie-down trench 90B and/or another feature that does not allow for a continuous recessed area and corresponding spacer member. Thus, as discussed with reference to some embodiments herein, a seat cushion 33B can include two or more different recessed areas and spacer members 40B, 41B. As shown in FIG. 14B, each recessed area can include its own fluid inlet 20B, 21B. The fluid inlets 20B, 21B can be in fluid communication with a single fluid module (not shown) or separate fluid modules, as desired or required. In other embodiments, one or more fluid ducts or other passages can be used to place the various recessed areas of a seat back and/or seat bottom portion in fluid communication with each other. For example, such an interconnecting duct or passage can be routed underneath one or more tie-down trenches and/or other features. As with other arrangements disclosed herein, it will be appreciated that the features illustrated in FIGS. 14A and 14B can be applied to the seat back portion, either in lieu of or in addition to the seat bottom portion.

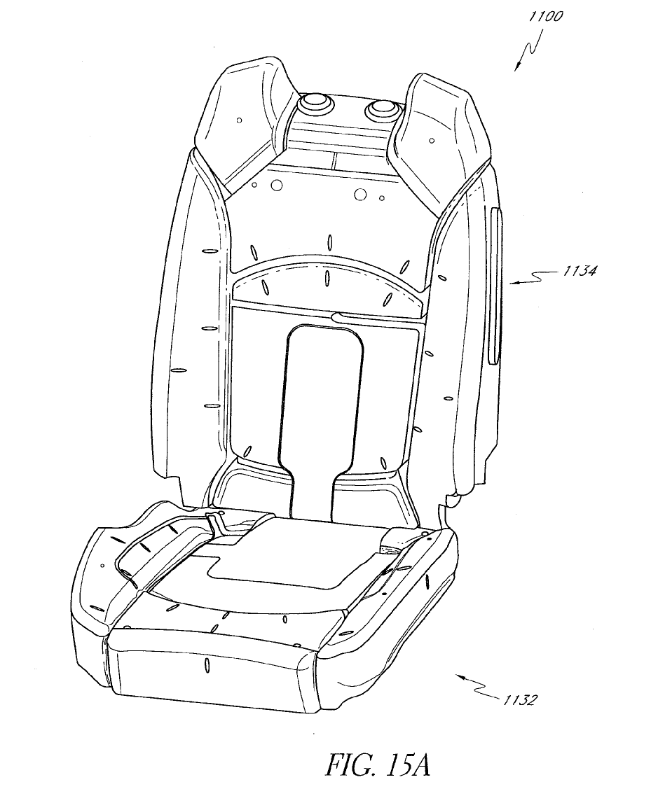

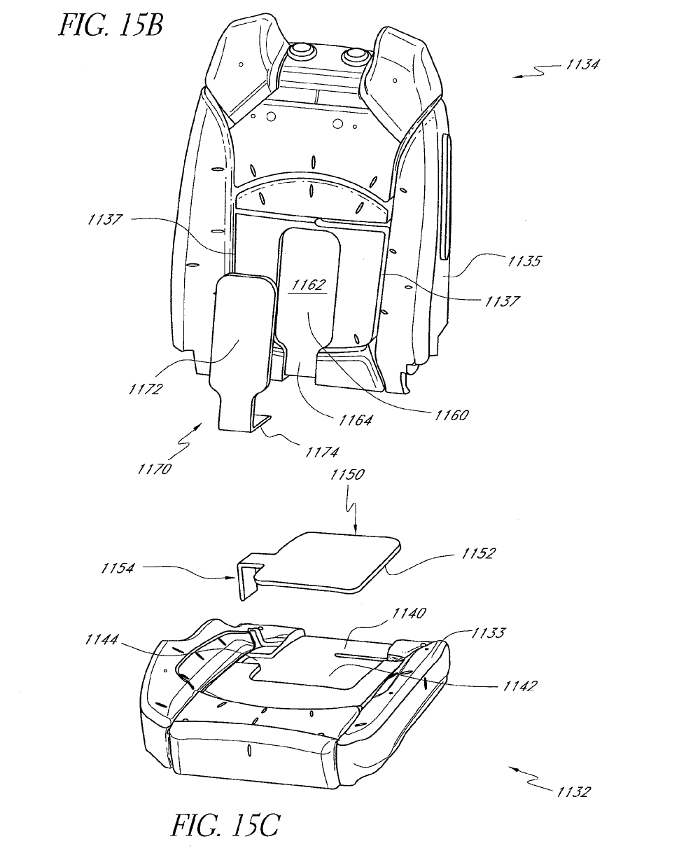

FIGS. 15A-15C illustrate one embodiment of a climate controlled seat assembly 1100 that includes one or more recessed areas 1140, 1160 along the exterior surfaces of the seat bottom portion 1132 and/or the seat back portion 1134. The depicted embodiment will be discussed with reference to the seat bottom portion 1132. However, it will be appreciated that the discussion applies equally to the seat back portion 1134.

With continued reference to FIG. 15C, the cushion 1133 of the seat bottom portion 1132 can include one or more recessed areas 1140 along an exterior surface. As discussed herein with respect to other arrangements, the shape, size, orientation and/or other details of such a recessed area 1140 can vary, as desired or required. In FIG. 15C, the recessed area 1140 comprises a main portion 1142 and an inlet portion 1144 generally located at or near an edge of the main portion 1142. However, instead of being positioned directly into the recessed area 1140, a spacer material (e.g., spacer fabric) and/or one or more other layers or members (e.g., a comfort layer, scrim, etc.) can be placed within an enclosure 1150 or other encapsulating member. Thus, a single enclosure 1150 can be sized, shaped and otherwise configured to be conveniently placed within a recessed area of the seating assembly. This can facilitate the assembly, transport, maintenance and/or other tasks associated with the manufacture and operation of climate controlled seat assemblies.

As illustrated in FIG. 15C, the enclosure 1150 can include an interface portion 1154 that is adapted to fit within the inlet portion 1144 of the recessed area 1140. Preferably, the interface portion 1154 can be routed through the cushion 1133 in order to place the enclosure 1150 and any components or members positioned therein (e.g., spacer member, comfort layer, etc.) in fluid communication with one or more fluid modules (not shown). Accordingly, conditioned (e.g., heated, cooled, etc.) and/or unconditioned (e.g., ambient) air or other fluids can be delivered to the recessed area 1140 of the seat bottom portion. In some embodiments, the enclosure 1150 comprises a plurality of openings (not shown) along its top and/or side surfaces to permit the air or other fluid that has been delivered into the enclosure 1150 from the fluid module to exit toward a seated occupant. One or more comfort layers, scrims, films and/or any other layer or member can be positioned on top and/or below the enclosure 1150, as desired or required. In other arrangements, an enclosure 1150 may not include a spacer member or any other member therein. As discussed herein and illustrated in FIG. 15B, a similar recessed area 1160 and corresponding enclosure 1170 can be provided for the seat back portion 1134, either in lieu of or in addition to the seat bottom portion 1132.

The recessed areas 1140, 1160 are preferably positioned at or near the middle of the seat bottom portion 1132 and/or the seat back portion 1134. For example, in one embodiment, the recessed area 1160 of the upper portion 1134 is generally located at least 15 mm away from each of the adjacent, vertically-oriented trenches 1137. However, in other embodiments, the recessed area 1160 and the enclosure 1170 positioned therein are within 15 mm of one or more trenches 1137 or other members. The shape, size, location, orientation and/or other details of the recessed areas 1140, 1160 and/or the enclosures 1150, 1170 can vary.

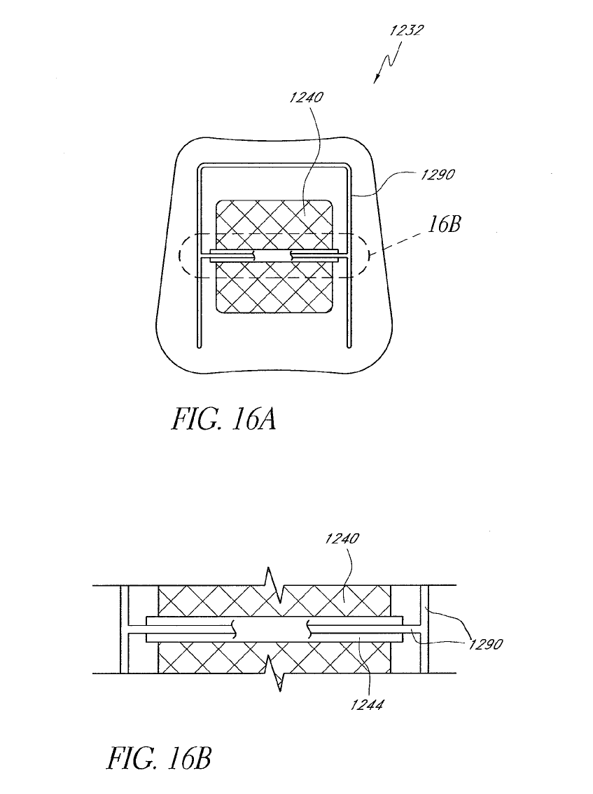

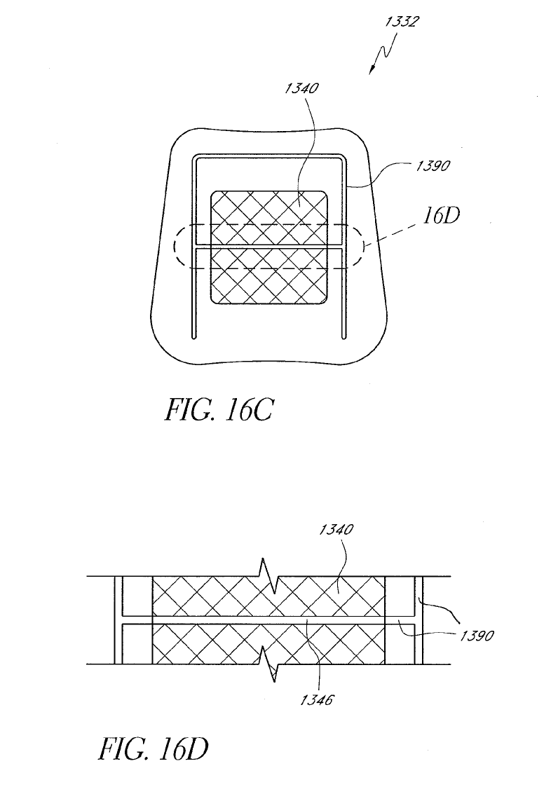

FIG. 16A illustrates a top view of seat bottom portion 1232 of a climate controlled seating assembly according to another embodiment. As shown, the seat bottom portion 1232 can include one or more styling seams 1290 to which a covering material can attach. In some arrangements, the styling seams 1290 are positioned within trenches (e.g., tie-down trenches) formed within a cushion of the seat assembly. In FIG. 16A, a styling seam 1290 is configured to traverse across a recessed area of the cushion, and thus, a spacer member 1240 positioned therein. Accordingly, as illustrated in the detailed view of FIG. 16B, a scrim strip 1244, deflector member or the like can be generally positioned between the spacer assembly 1240 and the styling seam 1290 that traverses across the recessed area. Such a scrim strip 1244 can help secure the styling seam 1290 to the top surface of the seat bottom portion 1232. Consequently, a covering material and/or any other layer can be properly applied to the seating assembly.

In other embodiments, as illustrated in FIGS. 16C and 16D, an attachment surface 1346 can be incorporated or otherwise secured to the top of the spacer assembly 1340. For example, the attachment surface 1346 can comprise a hook-and-loop fastener (e.g., Velcro), adhesives, adhesive strips and/or any other connection method or device. Accordingly, the styling seam 1390 can be effectively continued across one or more recessed areas and spacer assemblies 1340 positioned therein to facilitate attachment of a covering material or the like. In addition, for any of the embodiments disclosed herein, the use of hook-and-loop fasteners, adhesive strips, other adhesives and/or the like can be used to secure one or more portion of a climate control system (e.g., spacer, scrim comfort layer, film, heating mat or other heating device, etc.) to each other and/or to another portion of the seat assembly (e.g., a recessed area, another portion of the cushion, etc.).

It will be appreciated that in any of the embodiments of a climate controlled assembly disclosed herein, such as, for example those illustrated in FIGS. 1A through 16D, a fluid module or fluid transfer device can be configured to either deliver air or other fluid towards an occupant (e.g., the exterior side of a seat portion or seat back portion) or to draw fluid from an occupant. Thus, a fluid module or fluid transfer device can be configured to create a positive or a negative force at a fluid inlet. In some embodiments, an occupant can advantageously control whether such a fluid module or fluid transfer device operates in a “push” or “suction” mode. In addition, a climate controlled seating assembly according to any of the various embodiments disclosed herein, or variations thereof, can be configured to draw air or other fluid from one portion of a spacer assembly while simultaneously pushing air or other fluid through another portion of a spacer assembly and/or a completely different spacer assembly.

With respect to the various embodiments discussed and illustrated herein, one or more scrim layers can be integrated into a different subsystem or component. For example, a scrim layer can be attached to or otherwise joined with a heating member (e.g., heat mat or pad, etc.), an occupant sensing pad and/or the like. Further, a sensing pad, heat mat and/or other member included in the seating assembly can be configured to be activated either automatically or manually. In yet another embodiment, a heat mat or pad can be configured to act as a scrim layer. For example, as illustrated in FIG. 7B, the heat mat, pad or other member can include a plurality of orifices, slots and/or other openings to allow air or other fluid to pass therethrough.

According to some embodiments, a heat mat, pad or other heating device can be advantageously configured to allow for generally even distribution of heat to one or more exterior surfaces of a seating assembly. Further, such a heat mat can be configured to permit conditioned and/or unconditioned fluid being delivered into the recessed area to pass around the mat without the need for openings or other channels though the mat.

Further, with respect to the various embodiments discussed and illustrated herein, the scrim layer in combination with a spacer fabric can help provide balance and consistent feel to an occupant positioned on the seating assembly. This can help alleviate any comfort concerns resulting from sitting on or against uneven surfaces having transitions and other contour changes.

In some embodiments, regardless of the exact arrangement utilized, two or more of the components placed within the recessed area of a seat portion and/or a backrest portion can be joined to each other. For example, a spacer fabric can be attached to a scrim layer, a breathable fabric layer, a covering layer and/or the like.

To assist in the description of the disclosed embodiments, words such as upward, upper, downward, lower, vertical, horizontal, upstream, and downstream have and used above to describe the accompanying figures. It will be appreciated, however, that the illustrated embodiments can be located and oriented in a variety of desired positions.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of these inventions, will be readily apparent to those of skill in the art based upon this disclosure. It is also contemplated that various combinations or subcombinations of the specific features and aspects of the embodiments may be made and still fall within the scope of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above, but should be determined only by a fair reading of the claims that follow.

What is claimed is:

1. A climate controlled seating assembly comprising:
a cushion having an outer surface comprising a first side for supporting an occupant and a second side, the first side and the second side facing in generally opposite directions;
at least one cavity positioned within an interior of the cushion;
a recessed area along the first side of the cushion, the recessed area having a bottom surface, wherein said recessed area is in fluid communication with the at least one cavity; and
a spacer positioned within the recessed area, the spacer being at least partially fluid permeable and being configured to substantially retain the spatial integrity of the recessed area, said spacer configured to retain a three-dimensional shape when subjected to compressive forces;
wherein the spacer comprises a plurality of internal openings that permit air to pass therethrough; and
at least one heating element configured to selectively provide heat to a seated occupant;
wherein the at least one heating element is integrated directly into the spacer;
wherein the at least one heating element comprises at least one strand of conductive heating wire, said at least one strand of conductive heating wire being weaved directly into a structure of the spacer; and
a fluid module positioned completely within the at least one cavity of the cushion, such that the fluid module does not extend outside the outer surface of the cushion;
wherein the fluid module comprises a fluid transfer device configured to transfer air to and through the spacer to convectively heat said air when the at least one heating element is activated.

2. The climate controlled seating assembly of claim 1, wherein the recessed area is configured to further receive a scrim, said scrim comprising at least one opening through which fluids may pass.

3. The climate controlled seating assembly of claim 2, wherein the scrim comprises a padding layer configured to generally enhance the comfort to a seated occupant.

4. The climate controlled seating assembly of claim 1, wherein the recessed area comprises a generally rectangular shape.

5. The climate controlled seating assembly of claim 1, wherein the fluid module further comprises a thermal conditioning device configured to selectively heat or cool air being transferred by the fluid transfer device.

6. The climate controlled seating assembly of claim 5, wherein the thermal conditioning device comprises at least one thermoelectric device.

7. The climate controlled seating assembly of claim 5, wherein the thermal conditioning device comprises at least one convective heater.

8. The climate controlled seating assembly of claim 1, wherein the at least one heating element is positioned between the bottom surface of the recessed area and the outer surface along the first side of the cushion.

9. The climate controlled seating assembly of claim 1, wherein the at least one heating element comprises a plurality of slots or other openings, said slots or other openings being configured to permit air to pass therethrough.

10. The climate controlled seating assembly of claim 1, wherein the seating assembly comprises an automobile seat.

11. The climate controlled seating assembly of claim 1, wherein the seating assembly comprises a bed.

12. The climate controlled seating assembly of claim 1, wherein the spacer comprises a spacer fabric.

13. The climate controlled seating assembly of claim 1, wherein the spacer forms a generally unitary structure with the fluid module.

14. The climate controlled seating assembly of claim 1, wherein the spacer is separate from the fluid module.

15. A climate controlled seating assembly comprising:
a support member having an outer surface comprising a first side for supporting an occupant and a second side, the first side and the second side facing in generally opposite directions;
at least one upper recessed area positioned along the first side of the support member, said at least one upper recessed area having a bottom surface situated below the outer surface of the support member;
wherein the at least one upper recessed area extends only partially along the first side of the support member and defines a first perimeter area in a plane generally parallel with the first side;
at least one cavity extending below the bottom surface of the at least one upper recessed area and positioned within the support member, said at least one cavity being in fluid communication with the at least one upper recessed area;
wherein the at least one cavity defines a second perimeter area in the plane generally parallel with the first side, said second perimeter area being smaller than the first perimeter area;
a fluid module positioned entirely within the at least one cavity;
wherein the fluid module comprises a fluid transfer device configured to transfer air toward or from the first side of the support member, through the at least one upper recessed area; and
at least one spacer module positioned within the at least one upper recessed area, said at least one spacer module configured to permit air to pass therethrough and configured to generally retain the structural integrity of the at least one upper recessed area when an occupant is seated on the seating assembly;
wherein the at least one spacer module is configured to cover the at least one cavity and to permit air being transferred by the fluid module to pass therethrough.

16. The climate controlled seating assembly of claim 15, further comprising at least one heating element.

17. The climate controlled seating assembly of claim 16, wherein the at least one heating element is generally integrated into the at least one spacer module, said at least one heating element being configured to selectively at least partially heat air being passed through the at least one spacer module.

18. The climate controlled seating assembly of claim 15, wherein the fluid module comprises a thermal conditioning device configured to selectively heat or cool air being transferred by the fluid module.

19. The climate controlled seating assembly of claim 18, wherein the thermal conditioning device comprises at least one of a thermoelectric device and a convective heater.

20. The climate controlled seating assembly of claim 15, wherein the fluid module is permanently positioned within the at least one cavity.
